(19) United States
(12) Patent Application Publication
(10) Pub. No.: US 2001/0032222 A1
(43) Pub. Date: Oct. 18, 2001

(54) System, method and computer accessible storage medium, for creating and editing structured parts list

(75) Inventors: Susumu Takahashi, Yakohama-Shi (JP); Takashi Yanagimoto, Atsugi-Shi (JP); Hideo Mieno, Machida-shi (JP); Naoko Mieno, Machida-shi (JP); Tetsuo Kon, Isehara-Shi (JP); Hideji Miyanishi, Yakohama-Shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: RICOH COMPANY, LTD., Tokyo (JP)

(21) Appl. No.: 09/775,646

(22) Filed: Feb. 5, 2001

(30) Foreign Application Priority Data
Feb. 8, 2000 (JP) 2000-30155
Mar. 30, 2000 (JP) 2000-94614
May 15, 2000 (JP) 2000-141949
Jul. 6, 2000 (JP) 2000-204594

(51) Int. Cl. G06F 17/24

(52) U.S. Cl. 707/530; 707/531

(57) ABSTRACT

A structured parts list creating and editing system is disclosed, in which structured parts list information and parts information, of respective electronic parts, are stored in a resource DB 1 and approved DB 2, respectively. A resource parts list creating and editing unit 3 retrieves parts information on the respective parts, which is stored in the resource DB, produces a parts list, updates the parts list based parts information, and stores into a storage unit 6. A compatibility prediction information output unit 7, which is additionally provided, surveys on predetermined items based on the parts information list, and produces and then outputting decision information for compatibility prediction based on the results from the survey. The compatibility prediction information output unit may alternatively operate to store a variety of pieces of information on simulation models which are formed beforehand based on technical requirements, carry out simulation steps using various parameters corresponding to models selected from the simulation models, and generate prediction information based on simulation results.

### BACKGROUND

1. Field

This patent specification relates to a system and a method for creating and editing structured parts list information, and computer accessible storage medium configured to store structured parts list creating and editing programs, which are provided for a computer to execute, for a computer to execute, for components incorporated into a variety of systems such as circuit boards for electronic or electrical circuits, electronic apparatuses, manufacturing machines, engineering machines and other similar systems.

2. Discussion of the Background

It is well known to refer to various data of previous electronic circuit boards during designing new electronic circuits, to find suitable circuit boards for the new circuits.

When designing new circuits are proceeded in such a way that there needed are several procedures such as providing alteration to previous circuit boards, and designing new circuit boards. In addition, another procedure has to be added to supplement parts information related to new parts, into a structured parts table which was prepared to tabulate various parts arranged on the previous electronic boards, such as resistors, capacitors, ICs and others. The above noted new parts are to be included to materialize newly designed functions of the circuits, and information thereof has to be included as indicted above.

It is conventional in previous methods of designing for a circuit designer to refer one by one to either a catalogue or data sheet provided by manufacturers and find specific, desirable parts, having a function, size, price and others, which are suitable for the preset circuits, to thereby be able to supplement parts information concerning to these parts into the structured parts table.

During these procedures for identifying specific parts by referring to catalogue or data sheet, however, several drawbacks have been encountered, in which the style of the catalogue or the method for retrieving the data base may often differ from one to another depending on manufacturer, thereby causing undue workload for the designer and taking a prolonged period of time for tabulating a structured parts table for new electronic circuits.

In addition, the catalogue may be one of older versions, the data in which may be outdated. As a result, the data of the specified parts, such as, for example, specification, size and price may have already been altered, or the production thereof may have been discontinued.

In case where the structured parts list is updated based on these old data or catalogues, there may gives rise to undesirable effects, in which recreating structured parts table, parts substitution to other ones, or even the change in the initial design may become necessary, thereby incurring undue waste of time in the designing steps, among others.

Further, this may also causes additional drawbacks, which may possibly be realized after proceeding to the manufacturing phase, such that some of the parts in the structured parts table are not available, or desirable functions which are specified presently cannot be met. This may cause a considerable increase in manufacturing costs to amend the parts selection and processes, and even difficulty in manufacturing designed boards. Work efforts up to this point may therefore be wasted and process steps from designing through manufacturing have to be repeated. As a result, the above steps are considerably delayed and new products may not be input timely into the market, thereby incurring considerably loss to efficient electronic circuit board manufacturing.

### SUMMARY

Accordingly, it is an object of the present disclosure to provide a system and method capable of producing compatibility predictions for the parts of present interest so that predetermined conditions can be tested with relative ease, during process steps of creating and editing structured parts list information on component such as, for example, electronic circuit boards, based on the latest parts information.

The following description is a synopsis of only selected features and attributes of the present disclosure. A more complete description thereof is found below in the section entitled “Description of the Preferred Embodiments”

A system for creating and editing (creating/editing) structured parts list information disclosed herein includes at least a structured parts list information storage unit configured to store structured parts list information on components including a plurality of kinds of parts, a parts information storage unit configured to store parts information on a plurality of parts; a parts information list creating/editing unit configured to retrieve parts information on respective parts, stored in the structured parts list information storage unit, and create a parts information list; and a structured parts information list creating/editing unit configured to create updated structured parts list information based on the parts information list created by the parts information list creating/editing unit.

The parts information on respective parts include several pieces of information on at least identification, a function, a manufacture, a feature such as size and shape, future prospect, a price, and approval data related to approval and non-approval for use.

According to another aspect, the structured parts list information creating/editing system may further include a compatibility prediction information output unit configured to survey on predetermined items based on the parts information list produced by the parts list creating/editing unit, and create and then output decision information for compatibility prediction based on the results from the survey.

The predetermined items on respective parts may include at least packaging density, arrangement, and operation verification.

According to yet another aspect, the structured parts list information creating/editing system may further include an alternative compatibility prediction information output unit configured to store a variety of pieces of information on simulation models, formed beforehand based on technical requirements, carry out simulation steps using various parameters corresponding to models selected from the simulation models, and generates prediction information based on simulation results.

According to another aspect, the structured parts list information creating/editing system may include still another alternative compatibility prediction information output unit configured to estimate packaging densities for an arrangement with all components mounted within desired layout area based on the updated parts information list in the structured parts information list, and create and then output decision information for compatibility prediction based on packaging density results.

According to another aspect, the structured parts list information creating/editing system may further include another alternative compatibility prediction information output unit configured to estimate packaging densities for an arrangement with all components mounted within desired layout area based on the updated parts information list in the structured parts list information together with predetermined several restrictions, and create and then output decision information for compatibility prediction based on packaging density results.

The predetermined restrictions may include at least those concerning to layout blocked area, part height, connector position, part location, pattern routing, and equi-trace-length requirements.

According to another aspect, a method for creating/editing structured parts list information disclosed herein includes at least the steps of storing structured parts list information on components including a plurality of kinds of parts, storing parts information on components including a plurality of parts, retrieving parts information on respective parts stored in the structured parts list information, creating a parts information list of the respective parts, and creating and editing updated structured parts list information based on the parts information list.

The method for creating/editing structured parts list information may further includes additional steps of surveying on predetermined items based on the updated parts information list, and creating and then outputting decision information for compatibility prediction based on results from the survey.

The additional steps may alternatively be the steps of storing a variety of pieces of information on simulation models, formed beforehand based on technical requirements, carrying out simulation steps using various parameters corresponding to models selected from the simulation models, and creating prediction information based on simulation results.

The additional steps may be still alternatively the steps of estimating packaging densities for an arrangement with all components mounted within desired layout area based on the updated parts information list in the structured parts list information together with or without predetermined several restrictions, and creating and then outputting decision information for compatibility prediction based on packaging density results.

According to another aspect, a computer accessible storage medium is disclosed herein being configured to store structured parts list creating and editing programs for a computer to execute a plurality of processing steps. The processing steps include at least the steps of storing structured parts list information on components including a plurality of kinds of parts; storing parts information on components including a plurality of parts; retrieving parts information on respective parts, in the structured parts list information; creating a parts information list of the respective parts; and creating and editing updated structured parts list information based on the parts information list.

The processing steps may further include additional steps of surveying on predetermined items based on the updated parts information list, and creating and then outputting decision information for compatibility prediction based on results from the survey.

The additional processing steps may alternatively be the steps of storing a variety of pieces of information on simulation models, formed beforehand based on technical requirements, carrying out simulation steps using various parameters corresponding to models selected from the simulation models, and generating prediction information based on simulation results.

The additional processing steps may be still alternatively the steps of estimating packaging densities for an arrangement with all components mounted within desired layout area based on the updated parts information list in the structured parts list information together with or without predetermined several restrictions, and creating and then outputting decision information for compatibility prediction based on packaging density results.

Other objects, advantages and salient features of the present disclosure will become apparent from the detailed description which, taken in conjunction with the annexed drawings, discloses the preferred embodiments of the disclosure.

### BRIEF DESCRIPTION OF THE DRAWINGS

FIG. 1 is a block diagram illustrating the overall circuit construction of a structured parts list information creating and editing (creating/editing) system according to one embodiment disclosed herein;

FIG. 2 is a block diagram illustrating the overall circuit construction of a structured parts list information creating/editing system according to another embodiment disclosed herein;

FIGS. 3A, 3B and 3C are prepared to illustrate the data format used to store in the resource DB 1 of FIG. 1;

FIG. 4 includes a flow chart illustrating the process steps for creating/editing structured parts list, which are carried out by the structured parts list information creating/editing system of FIG. 1;

FIG. 5 illustrates a retrieval screen on the display during the creating/editing process steps of the structured parts list information;

FIG. 6 illustrates a structured parts list creating/editing screen on the display during the structured parts list creating/editing process steps;

FIG. 7 illustrates another structured parts list creating/editing screen on the display during the structured parts list creating/editing process steps;

FIG. 8 includes a flow chart illustrating the structured parts list creating/editing process steps carried out by the structured parts list creating/editing system of FIG. 2;

FIG. 9 includes a flow chart illustrating the structured parts list creating/editing process steps carried out by the structured parts list creating/editing system of FIG. 2;

FIG. 10 includes a flow chart illustrating the processing steps from editing a parts information list through a circuit layout;

FIG. 11 includes a flow chart illustrating the processing steps of surveying PWB packaging densities by means of the effective PWB packaging density examination tool;

FIG. 12 includes a screen on the display illustrating a main screen during survey and examination steps carried out by means of the effective PWB packaging density examination tool;

FIGS. 13A, 13B and 13C are prepared to illustrate screens on the display of the occupancy area ratios by the PWB parts, which are displayed in the PWB size display column 21;

FIG. 14 includes a graph illustrating a PWB packaging density plot according to the present embodiment, in which the density value of a plot is found larger by at least 2 pins/cm² than that of the upper limit curve;

FIG. 15 includes a graph illustrating another PWB packaging density plot according to the present embodiment, in which the density value of a plot is found smaller by at most 2 pins/cm² than that of the upper limit curve;

FIG. 16 includes a graph illustrating still another PWB packaging density plot according to the present embodiment;

FIG. 17 is prepared to illustrate a screen for displaying approximate PWB costs;

FIG. 18 is prepared to illustrate a screen for displaying parts prediction coefficients;

FIGS. 19A, 19B and 19C are prepared to illustrate screens for displaying the steps of resource part number input; and

FIGS. 20 and 21 include a flow chart illustrating processing steps for preparing a parts information list and examining a floorplan by the floorplanning tool.

### DESCRIPTION OF THE PREFERRED EMBODIMENTS

In the detailed description which follows, specific embodiments of structured parts list information creating/editing systems particularly useful in electronic circuit board construction are described. It is understood, however, that the present disclosure is not limited to these embodiments. For example, it is appreciated that the creating/editing systems such as disclosed herein may also be adaptable to other control apparatuses. Other embodiments will be apparent to those skilled in the art upon reading the following description.

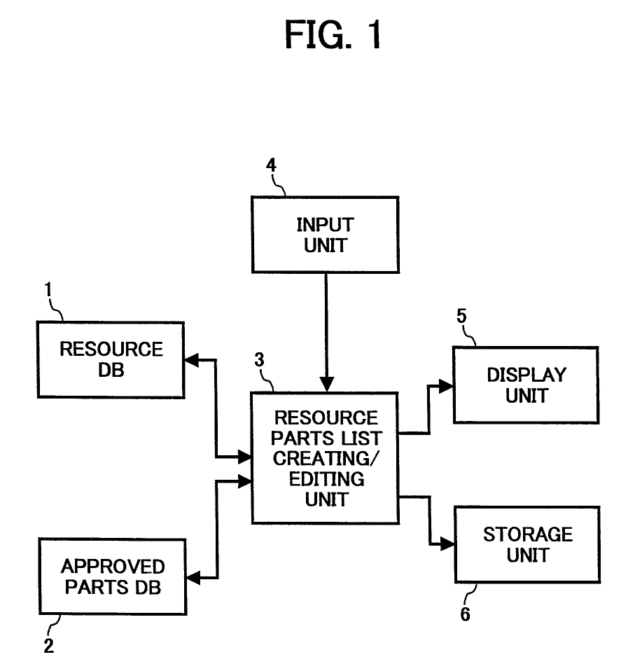

FIG. 1 is a block diagram illustrating the overall circuit construction of a structured parts list information creating/editing system according to one embodiment disclosed herein.

The structured parts list information creating/editing system disclosed herein is primarily an information processing system such as, for example, a personal computer including at least CPU, PROM, RAM and other similar devices.

This system is configured during the designing electronic circuits to carry out creating/editing processing operations onto updated information on structured parts list with respect to previously stored information of parts and structured parts list information of electronic circuit boards.

The thus prepared created/edited/re-edited structured parts list information may be utilized throughout succeeding process steps of circuit board manufacturing, such as designing circuit diagrams using component symbols, verifying the feasibility of desired circuit operations and functions, predicted goodness-of-fit regarding whether present structured parts list is compatible with various conditions previously determined during the circuit design process steps, also creates detailed circuit drawings, preparing parts lists and circuit diagrams to be utilized during manufacturing steps.

Referring to FIG. 1, a structured parts list creating/editing system disclosed herein includes at least a resource data base (DB) 1, an approved part data base (DB) 2, a resource parts list creating/editing unit 3, an input unit 4, a display unit 5 and a storage unit 6.

The resource DB 1 consists primarily a storage unit including at least hard disks and/or optical disks. The resource DB 1 is configured to operate as a data base (structured parts list information storage means) which stores a plurality of pieces of structured parts list information related to both previously designed electronic circuit boards and known electronic circuit boards. In addition, to each of the above structured parts list information of the electronic circuit boards, retrieval information is further provided as a keyword.

In addition, the resource DB 1 is configured to store retrieval information in a predetermined format appropriate to be capable to be readout based on the retrieval information.

The retrieval information includes a plurality of pieces of information regarding function, name, usage, manufacturer and/or user. Also, the parts information consists of name, manufacturer, model number, part number, quantity, unit price, and other similar parts data, for the parts such as resistors, capacitors, ICs and other similar devices, which are respectively incorporated into electronic circuit boards.

Based on the retrieval information, the retrieval of electronic circuit board information from the resource DB 1 becomes feasible according to required functions and use.

In addition, based on the structured parts list information retrieved from the resource DB 1, the retrieval also becomes feasible from approved parts DB 2 regarding parts information for various parts used during manufacturing steps.

The resource DB 2 also consists primarily of a storage unit including at least hard disks and/or optical disks. This resource DB 2 is configured to operate as a data base (parts information storage means) which register a plurality of pieces of parts information.

In addition, the resource DB 2 serves to store in a predetermined format that is appropriate readout retrieval information based on respective pieces of parts information. Further, respective parts information may also be stored in a predetermined format suitable for referring to a specific item in the information concerning to other components having functions comparable with the one presently retrieved, for example.

The above parts information includes a plurality of pieces of information of respective parts regarding identification, function, name of manufacturer, shape, prospect, price and/or approval data, which will be detailed herein below.

(1) Part Identification Information:

Serial numbers such as part number, component number and model number, affixed by either maker (manufacturer) or user to be used for part identification.

(2) Function Information:

Names to designate the function of respective parts, such as connector-interboards, transistor-resistor included-chip, logic-LS, resistor array-chip, capacitor-ceramic-ship, memory DRAM and other similar names.

Based on these names, the retrieval of parts information in the resource DB 2 becomes feasible regarding other components having functions comparable with the one presently retrieved. Namely, the retrieval may be carried out with relative ease regarding not only the parts used during manufacturing steps but also those having comparable functions.

In addition, the retrieved information may be sorted and subsequently displayed on a display unit 5 according to part items on the structured parts information list.

(3) Manufacturer Information

The names of manufacturer, manufacturing location, and its division and place.

(4) Shape Information

The size, shape, symbol to be appeared on circuit diagrams, footprint on electronic circuit boards, of the part.

(5) Future Prospect Information

Information regarding revision, discontinuation, completion of the part; changes of model number, part number and name; changes of part characteristics, part materials and manufacturing location; continuation or termination of manufacturing; changes of shape, size, notation method, processing method and style of packing; and future prospect information regarding further revision or discontinuation of the thus prepared revision and discontinuation information, change or fluctuation of unit price, prospect on stable part supply, and ease or difficulty in part availability.

(6) Price Information

Unit price such as current price and unit price when mass-produced.

(7) Approval Information (Alternatively Called Status Information)

Information regarding whether the part of interest is approved for the present electronic circuits, either with or without limitation. This information provides judgment criteria for effective parts selection, that is carried out based on the above information regarding structured parts information and characteristics.

The approval information may be represented in terms of, for example, ‘recommended’ which indicates that the selection of the part is positively recommended, ‘approved’ indicating the selection is recommended, ‘tentatively approved’ indicating the evaluation for the approval is still in progress, ‘not recommended’ indicating the selection cannot be approved, ‘limited’ indicating the selection is approved with several limitations such as, for example, relatively difficult availability, ‘prohibited’ indicating the use is prohibited, ‘discontinued’ indicating the part manufacturing has been terminated or discontinued, and ‘rejected’ indicating the part registration to the approved parts DB 2 has been rejected.

The resource parts list creating/editing unit 3 assumes the overall control of the structured parts list creating/editing system.

The creating/editing unit 3 is configured to retrieve structured parts list information concerning to electronic circuit boards, which is stored in the resource DB 1; readout the thus retrieved structured parts list information; from the approved parts DB 2, retrieve and then readout the parts information on respective parts corresponding to the above retrieved structured parts list information (including parts information during electronic board manufacturing process steps as well as presently updated parts information in inclusive of other components having functions comparable with the one presently retrieved); and prepare a parts information list based on the above obtained parts information.

The creating/editing unit 3 is also configured to achieve processing operation for the parts information list be displayed on a display unit 5 for creating/editing the structured parts list information based on the parts information list; substitute, delete and/or supplement the content of the parts information in the parts information list according to operation instruction input from an input unit 4, to thereby create/edit the structured parts list information; and write the structured parts list information into the storage unit 6, to thereby achieve the registration of the information.

The input unit 4 consists primarily of input devices such as, for example, a keyboard and mouse. The input unit 4 is configured to input a variety of input instructions for a user either to retrieve, from the resource DB 1, the structured parts list information regarding the desired electronic circuit boards, based on a screen for retrieval displayed on the display unit 5; or to create/edit an updated structured parts list based on the structured parts list displayed on the display unit 5.

The display unit 5 consists primarily of display devices such as, for example, CRT and LCD. The display unit 5 is configured to display work sheet screens on the display, structured parts lists, and other similar screens during creating/editing steps of the work sheets and structured parts information.

The storage unit 6 consists primarily of storage devices such as, for example, hard disks and optical disks. The storage unit 6 is configured to store the structured parts list information prepared as above.

As described herein above, in the present embodiment, the resource DB 1 serves as the structured parts list information creating/editing storage means to be capable of storing a plurality of pieces of information of structured parts lists information creating/editing constituted of various kinds of electronic components. Similarly, the resource DB 2 serves as parts information storage means to be capable of storing a plurality of pieces of parts information concerning to their identification, function, manufacturer, size, shape, future prospect, price and approval data regarding, for example, whether the part of interest is approved for present use.

In addition, the resource parts list creating/editing unit 3 serves as means to prepare a parts information list and to create/edit the structured parts list information.

The former means to prepare a parts information list operate to retrieve the parts information of respective parts in the structured parts list information, which is stored from the parts information, and to prepare a parts information list for respective parts included in the structured parts list information. The latter means to create/edit the structured parts list information operates to create and edit updated structured parts list information based on the parts information list prepared by the former means to prepare a parts information list, as described above.

The data format used in the resource data bases will be detailed herein below.

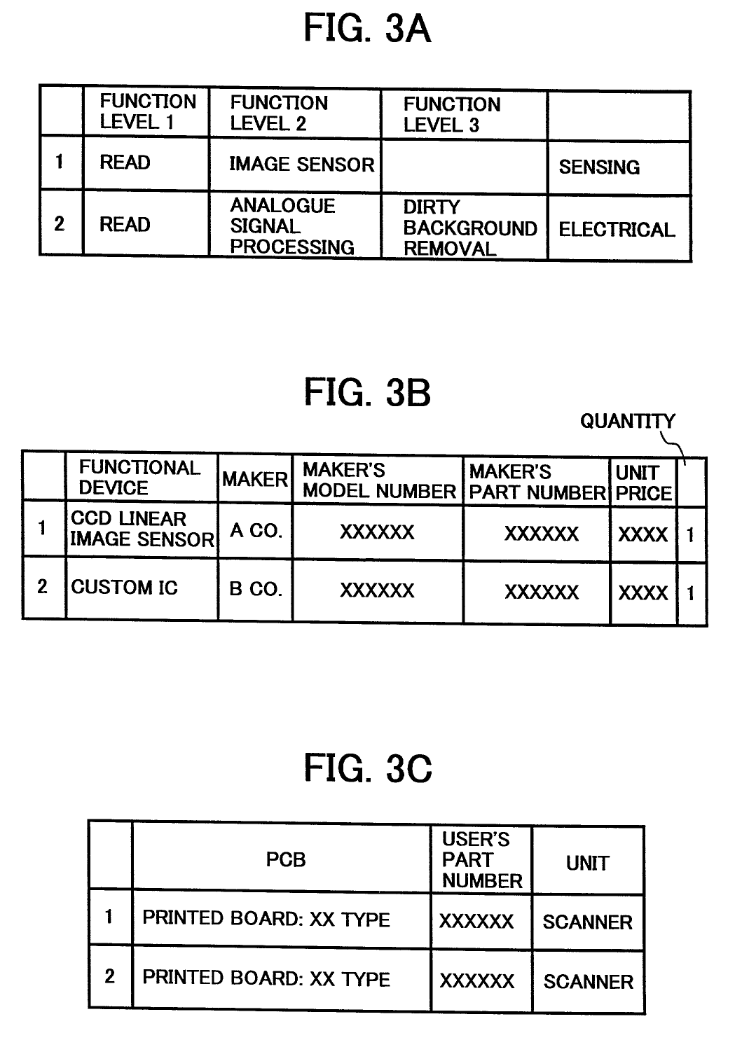

FIGS. 3A, 3B and 3C are prepared to illustrate the data format used to store in the resource DB 1 of FIG. 1. Although retrieval information shown in FIG. 3A is divided into three levels, the information may alternatively be stored as one record.

As shown in FIGS. 3A, 3B and 3C, the retrieval information consists of a variety of items such as a plurality of function levels, control factor, functional device, maker's name, model number and part number; unit price, quantity, PCB name, user's model number and unit number, and other similar items.

(1) Plural Function Levels

Function level information divided into a plurality of levels of the part function.

Three levels of the information are assumed in FIG. 3A, illustrating respectively the function explanatory information such as, for example, ‘writing’ at the function level 1, information concerning to function name at the function level 2, and detailed function explanatory information such as, for example, ‘removal of surface texture’ at the function level 3.

(2) Control Factor

The factor to which the function of part of interest is operative on electronic circuit boards, such as, for example, ‘sensing’ and ‘electric’.

(3) Functional Device Name

Concrete part names such as, for example, ‘CCD linear image sensor’ and ‘custom IC’.

(4) Maker's Name

Name of the manufacturer of the electronic part of interest.

(5) Maker's Model Number

Model number affixed by the maker onto the electronic part.

(6) Maker's Part Number

Part number affixed by the maker onto the electronic part.

(7) Unit Price

Information concerning to the unit price, put by the maker or offered in the market.

(8) Quantity

The number of the part of interest, which is included in a unit (see below) consisting the electronic parts.

(9) PCB Name

Name of the printed-circuit board.

(10) User's Model Number

Model number arbitrary affixed by the user onto the electronic circuit board.

(11) Unit

The unit name, such as, for example, ‘scanner’ and ‘printer’.

These pieces of the retrieval information may additionally be provided with ‘use information’ concerning the use of the part, for example.

In addition, although not shown in FIGS. 3A, 3B and 3C, these pieces of the retrieval information may also be added to the structured parts list information of the electronic circuit board, as described earlier.

The retrieval of desirable circuit boards information is carried out with the thus prepared pieces of the retrieval information through and-, or or-retrieval steps. In addition, based on structured parts list information of the thus retrieved electronic circuit board, corresponding parts information can be retrieved and readout from the approved parts DB 2. Further, parts information regarding the other parts having comparable functions may also be retrievesd and readout based on respective items included in the readout parts information.

There detailed herein below are structured parts list creating/editing process steps which are carried out by the structured parts list creating/editing system disclosed herein.

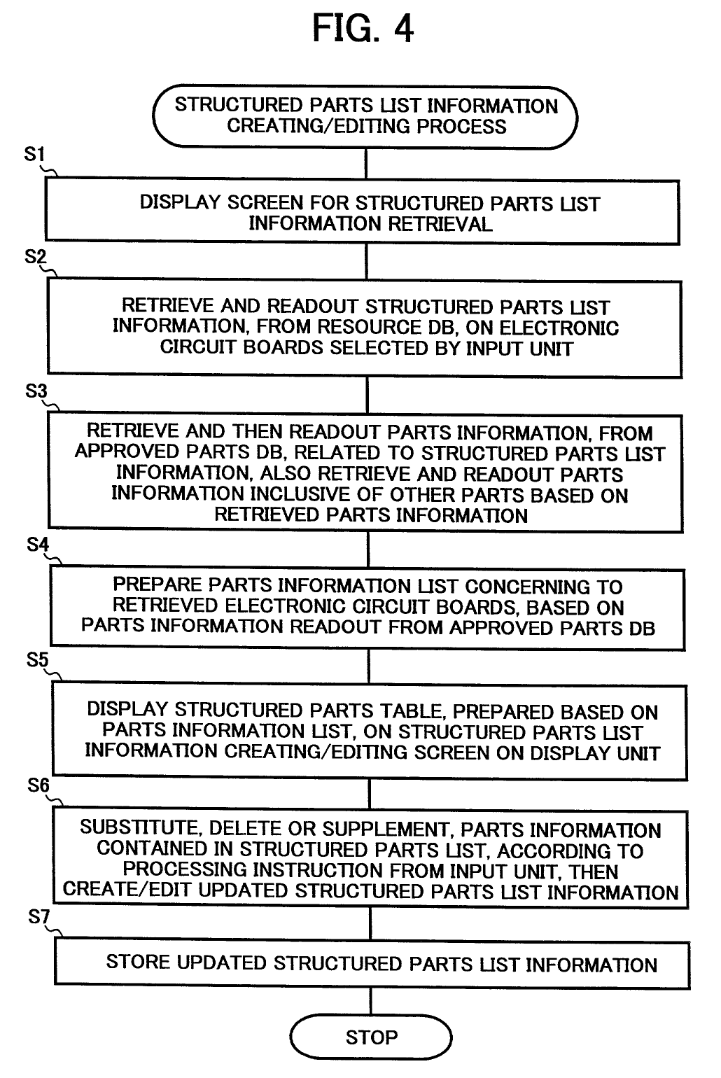

FIG. 4 includes a flow chart illustrating the structured parts list creating/editing process steps carried out by the structured parts list creating/editing system of FIG. 1.

In Step 1 of the creating/editing process steps (which is shown as ‘S1’ in FIG. 4), the resource parts list creating/editing unit 3 operates to display a screen on the display for the structured parts list information retrieval.

The process proceeds to Step 2. In Step 2, the unit 3 operates to retrieve, from the resource DB 1, structured parts list information on electronic circuit boards which corresponds to certain keywords (or retrieval information) input from the input unit; and display a table containing all pieces of retrieval information for the applicable electronic circuit boards, then readout structured parts list information related to the electronic circuit boards specifically selected by the input unit.

Subsequently, the process proceeds to Step 3. In Step 3, the unit 3 operates to retrieve, from the approved parts DB 2, parts information related to the thus readout structured parts list information; and retrieve readout parts information inclusive of other corresponding parts based on respective pieces of retrieved parts information (for example, function information).

The process then proceeds to Step 4. In Step 4, a parts information list is prepared concerning to the above retrieved electronic circuit board information, based on the respective pieces of parts information readout from the approved parts DB 2.

Subsequently, in Step 5, a structured parts table is displayed based on the parts information list, including parts information concerning to the parts used during manufacturing steps, on the structured parts list information creating/editing screen on the display unit, also the unit 3 enables to refer to parts information concerning to various other parts.

Further, in Step 6, the unit 3 carries out the operation steps for creating/editing the structured parts list information such as, substituting the piece of the parts information, contained in the structured parts list, of certain specified parts with the information for other parts, having comparable functions; deleting the piece of the parts information, contained in the structured parts list, of a certain specified part; and supplementing parts information of other new parts.

The process then proceeds to Step 7. In Step 7, the unit 3 instructs to store, into the storage unit, updated structured parts list information which is created/edited on the basis of the thus prepared structured parts list, then the process ends.

There exemplified herein below are working screens on the display and processing operations therewith during the creating/editing process steps of the structured parts list information.

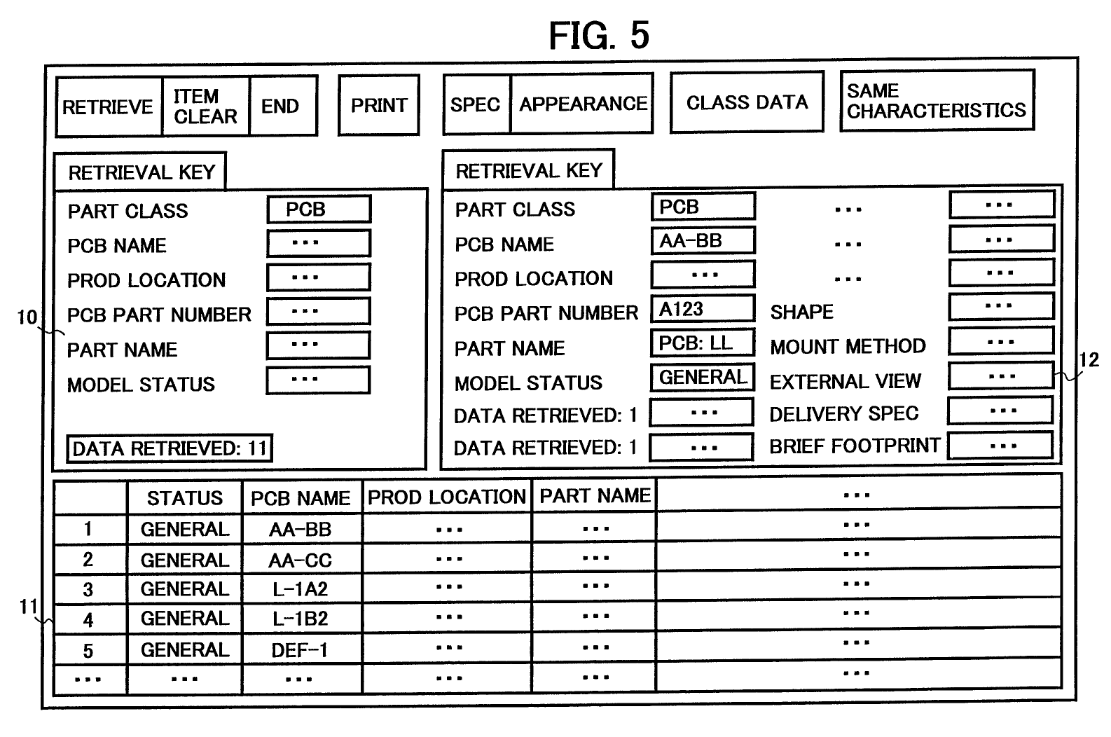

FIG. 5 illustrates a retrieval screen on the display during the creating/editing process steps of the structured parts list information.

Referring to FIG. 5, when a keyword in the retrieval key input column 10 is selected during the process steps, corresponding to a certain presently desired item among various items such as unit or part class, PCB name, manufacturing location, PCB part number, part name (part number), and model status (model number), there displayed in retrieval result display column 11 is a table containing the portions of retrieval information retrieved from the resource DB 1 concerning to corresponding electronic circuit boards. In addition, more detailed information is displayed in retrieval result display column 12, concerning to a certain electronic circuit board selected among the boards in the table.

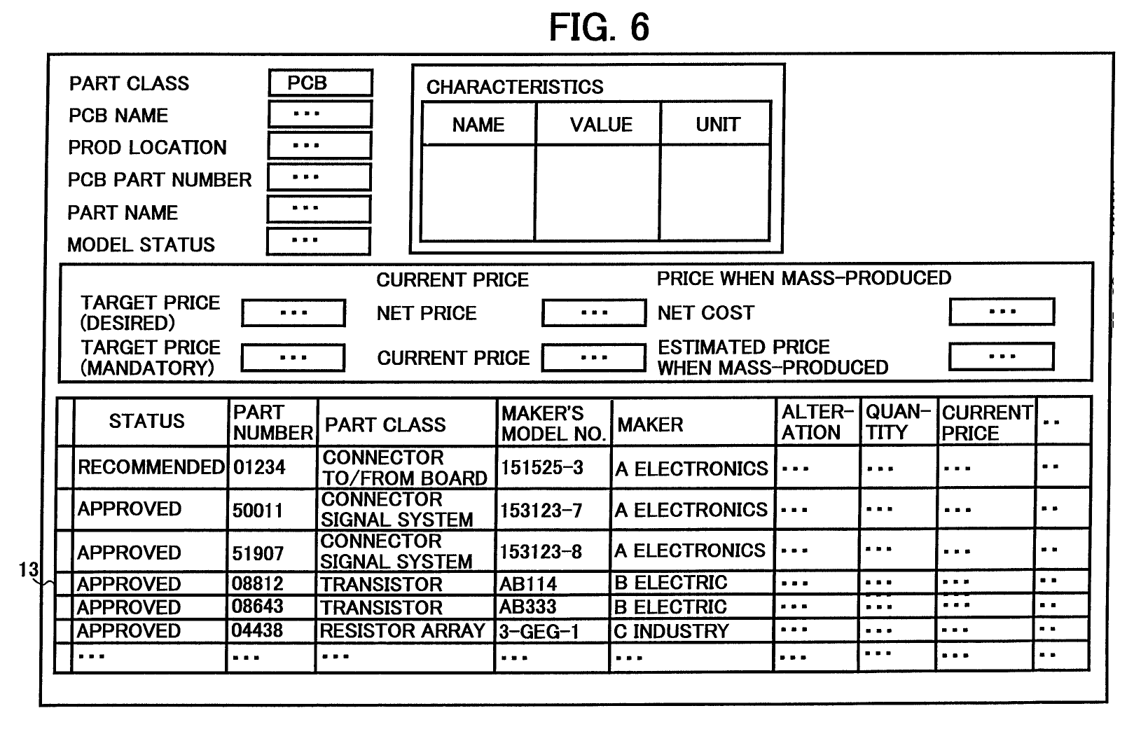

FIG. 6 illustrates a structured parts list creating/editing screen on the display during the structured parts list creating/editing process steps.

Referring to FIG. 6, when a desired electronic circuit board is selected during the process steps among the boards retrieved as descried just above, and when a resource input instruction is input, parts information concerning to the electronic circuit board corresponding to those presently selected is retrieved from the approved parts DB 2 based on the structured parts list information of the above selected electronic circuit board, and the resulting parts information is displayed in parts information list column 13 on the display.

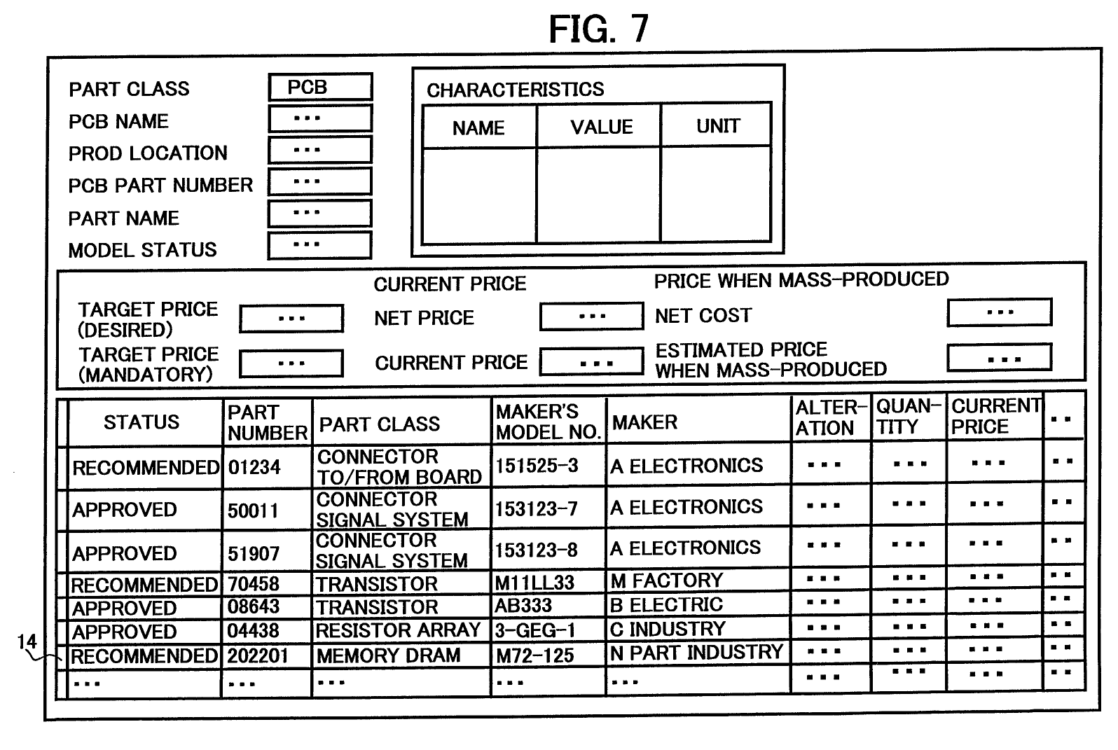

FIG. 7 illustrates another structured parts list creating/editing screen on the display during the structured parts list creating and editing process steps.

Referring to FIG. 7, when substitution processing from some of the parts to others is intended in the parts information list column 13, the substitution step is carried out by first selecting the parts to be substituted are selected in the column 13, then instructing to refer to those having comparable functions. The results containing the information on the retrieved parts having comparable functions are additionally displayed in the column 13 next to the lines previously displayed. Subsequently, by selecting parts among those in the thus updated list, the substitution is carried out from the parts to be substituted to those selected as above.

Also, when supplementing process of new parts is intended, supplementing steps are carried out, as shown in FIG. 7, by instructing the supplementing steps of parts information (indicated by the arrow 14 in FIG. 7) concerning to the retrieved parts based on, for example, the current price (part price). According to the instruction, the above parts information is subsequently supplemented into the parts information list column 13. In addition, several pieces of the information in the list 13 may also be deleted in a similar manner.

As described herein above, based on the structured parts list information concerning to previously manufactured electronic circuit boards, updated structured parts list information is thus created/edited after incorporating new capabilities and stored into the storage unit 6, to subsequently be transferred to the following manufacturing steps of the electronic circuit board fabrication.

Incidentally, the structured parts list creating/editing system is detailed so far primarily on its functional unit specifically related to the embodiment disclosed herein. It may be added, however, that other functional units may additionally be provided. For example, the units may be ones used in circuit designing such as designing, drawing, verifying and other similar functional units.

With the units having above described capabilities, and based on the thus prepared updated structured parts list information of electronic circuit boards, various process steps of circuit design becomes feasible including designing, drawing, and verifying, by means of a single system.

In addition, the structured parts list creating/editing system may further be able to carry out parts selection process steps more efficiently.

Namely, in the structured parts list creating/editing system, the resource DB 1 and approved parts DB 2 are interconnected by way of communication network such as, for example, the public telephone network or optical communication network, and further incorporating a number of other structured parts list creating/editing systems to be mutually linked by way of the communication network so that for the resource DB 1 and approved parts DB 2 be able to be referred each other and from the other structured parts list creating/editing systems as well. Since the construction of the above noted structured parts list creating/editing systems with the resource DB 1 and approved parts DB 2 through the network enables for these data bases be utilized by a number of users, as common data bases, this may considerably facilitate efficient process steps of selecting most suitable parts for the electronic circuit boards presently concerned.

Although there is detailed so far in the present embodiment, on a rather specific system construction of the creating/editing system in exclusive use for the above noted structured parts list creating/editing process steps, the above noted creating/editing process steps may also be carried out with an information processing apparatus such as, for example, a conventional personal computer, in which programs for the above noted process steps is installed in a storage medium such as, for example, a floppy disk and optical disk, then executed by a control unit in the information processing apparatus (functional units embodied in the apparatus such as CPU, ROM, RAM and other similar devices).

Namely, the above noted storage media such as floppy disk and optical disk serve as storage means to store various programs of processing steps to subsequently be utilized for executing the programs, having capabilities comparable to those with storage unit in the aforementioned structured parts list creating/editing system.

These capabilities or functions are (1) structured parts list information storage functions capable of storing a plurality of pieces of information of structured parts list constituted of various kinds of electronic components, (2) parts information storage functions capable of storing a plurality of pieces of parts information concerning to identification, function, manufacturer, size, shape, future prospect, price and approval data regarding, for example, whether the part of interest is approved for present use, (3) resource parts list creating/editing functions capable of preparing a parts information list by first retrieving the parts information of respective parts in the structured parts list information, which is stored from parts information, then preparing a parts information list for respective parts included in the structured parts list information and (4) structured parts list information creating/editing functions capable of creating/editing an updated structured parts list information based on the parts information list prepared as described above.

Subsequently, a control unit in the above noted information processing apparatus such as a conventional personal computer executes, based on the parts information list prepared above, various processing steps such as storing a plurality of pieces of information on structured parts list, storing a plurality of pieces of parts information concerning to identification, function, manufacturer, size, shape, future prospect, price and approval data regarding whether the part of interest is approved for present use; preparing a parts information list by first retrieving the parts information of respective parts in the structured parts list information, then preparing a parts information list for respective parts included in the structured parts list information; and creating/editing an updated structured parts list information based on the parts information list prepared above.

According to the embodiment disclosed herein, it becomes not mandatory, for respective parts to be referred one by one to either a catalogue or data sheet provided by the manufacturer during creating/editing steps of new structured parts list information concerning to the electronic circuit boards. Therefore, workloads of reference and/or retrieval works may considerably be reduced.

In addition, since the parts information to be presently referred is generally the latest for the parts and aforementioned status information (or approval information) especially useful in decision making steps can also be referred, structured parts list information concerning to new electronic circuit boards can be prepared efficiently in relatively short period of time.

Through the above updated structured parts list information, undesirable effects can be avoided, which are caused by possible undue situations such as, for example, changes in specification, shape and/or price, or discontinuation of manufacturing of the parts, which are unnoticed up to the point of, or after creating the parts information. In such cases, recreating structured parts list information, parts substitution to other ones, or even the change in the initial design may otherwise be necessitated. Namely, by providing the updated structured parts list information, unfavorable situations against efficient electronic circuit board manufacturing and concurrent undue waste of manufacturing costs can therefore be alleviated.

Further, since the updated structured parts list information can quickly be transferred to, or shared by, various processes, succeeding steps from development through manufacturing processes can proceed smoothly, thereby enabling new products be input timely into the market.

Incidentally, although the creating/editing process steps according to the present embodiment are detailed on structured parts list information based on parts information concerning to electronic circuit boards, these process steps may also be adopted to other apparatus such as, for example, machine tools and control apparatus in a similar manner.

Namely, this may be carried out by storing structured parts list information of various machine tools and other similar apparatus into a resource DB, storing parts information of various machine tools and other similar apparatus into an approved parts DB, and retrieving the parts information of corresponding parts by the resource parts list creating/editing unit from the resource DB based on the structured parts list information retrieved from the resource DB, then preparing a parts information list, to thereby for these process steps to be adopted to other apparatuses, as well.

A structured parts list information creating/editing system according to another embodiment will be described herein below.

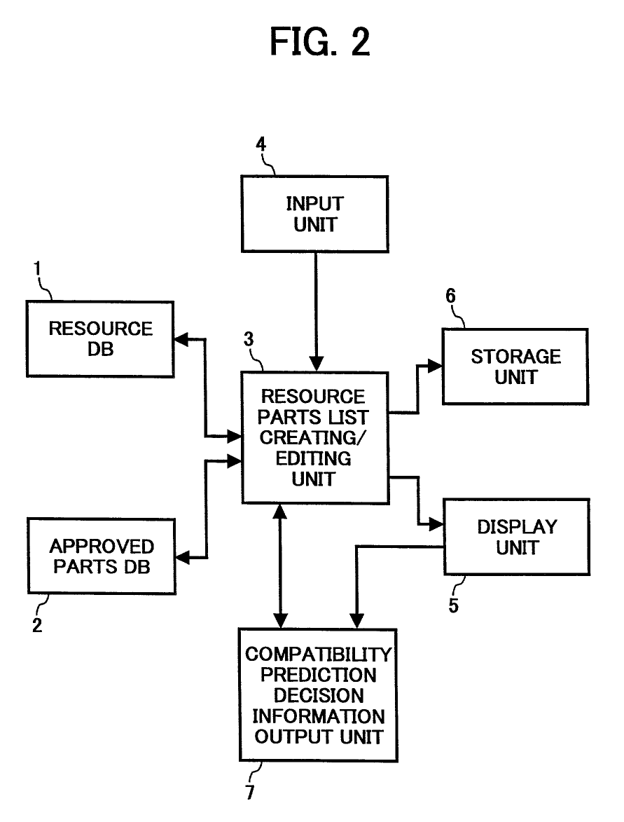

FIG. 2 is a block diagram illustrating the overall circuit construction of the structured parts list information creating/editing system according to this second embodiment disclosed herein.

It is noted that, in the following description, the structure and process steps common to those included in the first embodiment are not described so much in detail, since they obscure the present disclosure in unnecessary detail.

The structured parts list information creating/editing is an information processing system such as, for example, a personal computer including at least CPU, PROM, RAM and other similar devices.

This system is configured during the designing electronic circuits to carry out creating/editing processing operations onto updated information on structured parts list with respect to previously stored information of parts and structured parts list information of electronic circuit boards.

The system is also configured to survey predetermined verification items (including the function for verifying the feasibility of desired circuit operations and functions) based on a parts information list of the structured parts list information, then output decision information, based on results from the survey, to be utilized for goodness-of-fit prediction regarding whether present structured parts list is compatible with various conditions determined during the circuit design process steps.

A design engineer may also re-edit obtained structured parts list information based on the decision information.

The thus prepared created/edited/re-edited structured parts list information may be utilized throughout succeeding process steps of circuit board manufacturing, such as designing circuit diagrams using component symbols, and creating detailed circuit drawings, preparing parts lists and circuit diagrams to be utilized during manufacturing steps.

Referring to FIG. 2, a structured parts list creating/editing system according to this second embodiment is further provided with a compatibility prediction information output unit 7, in addition to the units included in the system according to the previous embodiment, such as the resource DB 1, approved parts DB 2, resource parts list creating/editing unit 3, input unit 4, display unit 5 and storage unit 6.

The resource DB 1 consists primarily a storage unit including at least hard disks and/or optical disks. The resource DB 1 is configured to operate as a data base which stores a plurality of pieces of structured parts list information related to both previously designed electronic circuit boards and known electronic circuit boards. In addition, to each of the above structured parts list information of the electronic circuit boards, retrieval information is further provided as a keyword.

In addition, the resource DB 1 is configured to store retrieval information in a predetermined format appropriate to readout based on the retrieval information.

The retrieval information includes a plurality of pieces of information regarding function, name, usage, manufacturer and/or user. Also, the parts information consists of name, manufacturer, model number, part number, quantity, unit price, and other similar part data, for the parts such as resistors, capacitors, ICs and other similar devices, which are respectively incorporated into electronic circuit boards.

Based on the retrieval information, the retrieval of electronic circuit board information from the resource DB 1 becomes feasible according to required functions and use.

In addition, based on the structured parts list information retrieved from the resource DB 1, the retrieval also becomes feasible from approved parts DB 2 regarding parts information for various parts used during manufacturing steps.

The resource DB 2 also consists primarily of a storage unit including at least hard disks and/or optical disks. This resource DB 2 is configured to operate as a data base (parts information storage means) which register a plurality of pieces of parts information.

The resource DB 2 serves to store in a predetermined format that is appropriate to readout retrieval information based on respective pieces of parts information. Further, respective parts information may also be stored in a predetermined format suitable for referring to a specific item in the information concerning to other components having functions comparable with the one presently retrieved, for example.

The above parts information includes a plurality of pieces of information of respective parts regarding identification, function, name of manufacturer, shape, prospect, price and/or approval data, which are created/edited in a similar manner to those described earlier in the first embodiment.

The resource parts list creating/editing unit 3 assumes the overall control of the structured parts list creating/editing system.

The creating/editing unit 3 is configured to retrieve structured parts list information concerning to electronic circuit boards, which is stored in the resource DB 1; readout the thus retrieved structured parts list information; from the approved parts DB 2, retrieve and then readout the parts information on respective parts corresponding to the above retrieved structured parts list information (including parts information during electronic board manufacturing process steps as well as presently updated parts information in inclusive of other components having functions comparable with the one presently retrieved); and prepare a parts information list based on the above obtained parts information.

The creating/editing unit 3 is also configured to achieve processing operation for the parts information list be displayed on a display unit 5 for creating/editing the structured parts list information based on the parts information list; substitute, delete and/or supplement the content of the parts information in the parts information list according to operation instruction input from an input unit 4, create/edit the structured parts list information, write the structured parts list information into the storage unit 6, thereby achieving the registration of the information, and output the thus prepared updated parts information list to the compatibility prediction information output unit 7.

The input unit 4 consists primarily of input devices such as, for example, a keyboard and mouse. The input unit 4 is configured to input a variety of input instructions for a user to retrieve, from the resource DB 1, the structured parts list information regarding the desired electronic circuit boards, based on a screen for retrieval displayed on the display unit 5; to create/edit/re-edit an updated structured parts list based on the structured parts list displayed on the display unit 5, to input instruction information for either carrying out the survey of a plurality of the predetermined kind of items or outputting decision information for compatibility prediction based on results of the survey.

The display unit 5 consists primarily of display devices such as, for example, CRT and LCD. The display unit 5 is configured to display work sheet screens on the display, structured parts lists, other similar screens during creating/editing/re-editing steps of the work sheets and structured parts list information, results from the survey, decision information for compatibility prediction, and other similar piece of information.

The storage unit 6 consists primarily of storage devices such as, for example, hard disks and optical disks. The storage unit 6 is configured to store the structured parts list information prepared as above.

The compatibility prediction information output unit 7 is configured to carry out several processing operations, which follows. Namely, based on the parts information list created/edited/re-edited by the resource parts list creating/editing unit 3, the output unit 7 examines several items such as, for example, printed-wiring board (PWB) packaging density, PWB manufacturing cost, parts floorplan, and simulation (circuit operation verification); and prepares decision information for compatibility prediction based on the results from the above examination, then instructs to display both the thus prepared decision information and the results from the above examination on the display unit 5.

In regard to the examination item on the PWB packaging density, the output unit 7 examines the packaging density of the parts on circuit boards, based on the parts information list in structured parts list information; and prepares decision information for predicting the compatibility with predetermined requirements (feasibility, for example) i.e., relative readiness or difficulty in packaging process based on the results from the examination, to subsequently display the thus prepared results.

In regard to the PWB manufacturing cost, the output unit 7 examines manufacturing costs of circuit boards, on which electronic parts are to be mounted, based on the parts information list in structured parts list information; and prepares decision information for predicting the compatibility with predetermined requirements (predetermined manufacturing costs) based on the results from the examination, to subsequently display thus obtained results.

In regard to the parts floorplan, the output unit 7 examines parts arrangements on circuit boards, and prepares decision information for predicting the compatibility with predetermined requirements (feasibility of parts arrangements into a predetermined chip area) based on the results from the examination, to subsequently display thus obtained results.

In regard to the simulation (circuit operation verification), the output unit 7 carries out the operation verification for either the whole, or the portions of the circuits on the PWB, and prepares decision information for predicting the compatibility with predetermined requirements (predetermined operation characteristics) based on the results from the examination, to subsequently display thus obtained results.

The resource DB 1 and approved parts DB 2 assume the similar functions to those described earlier in the first embodiment.

In addition, the resource parts list creating/editing unit 3 assumes the overall control of the structured parts list creating/editing system in similar manner again to that described earlier in the first embodiment. Namely, the resource parts list creating/editing unit 3 thus serves as the means to prepare a parts information list and to create/edit the structured parts list information, in which the former means to prepare a parts information list operates to retrieve the parts information of respective parts in the structured parts list information, which is stored from parts information, and to prepare a parts information list for respective parts included in the structured parts list information. The latter means to create/edit the structured parts list information operates to create/edit updated structured parts list information based on the parts information list prepared by the former means to prepare a parts information list, as described above.

In addition, the compatibility prediction information output unit 7 serves to carry out examinations on several predetermined items, based on the updated parts information list created/edited by the resource parts list creating/editing unit, and prepares decision information for compatibility prediction based on the results from the above examination, then instructs to display the decision information.

The resource DB 1 in the present embodiment has a similar data format to that described earlier in the first embodiment (FIGS. 3A, 3B and 3C).

There detailed herein below are structured parts list creating/editing process steps which are carried out by the structured parts list creating/editing system disclosed herein.

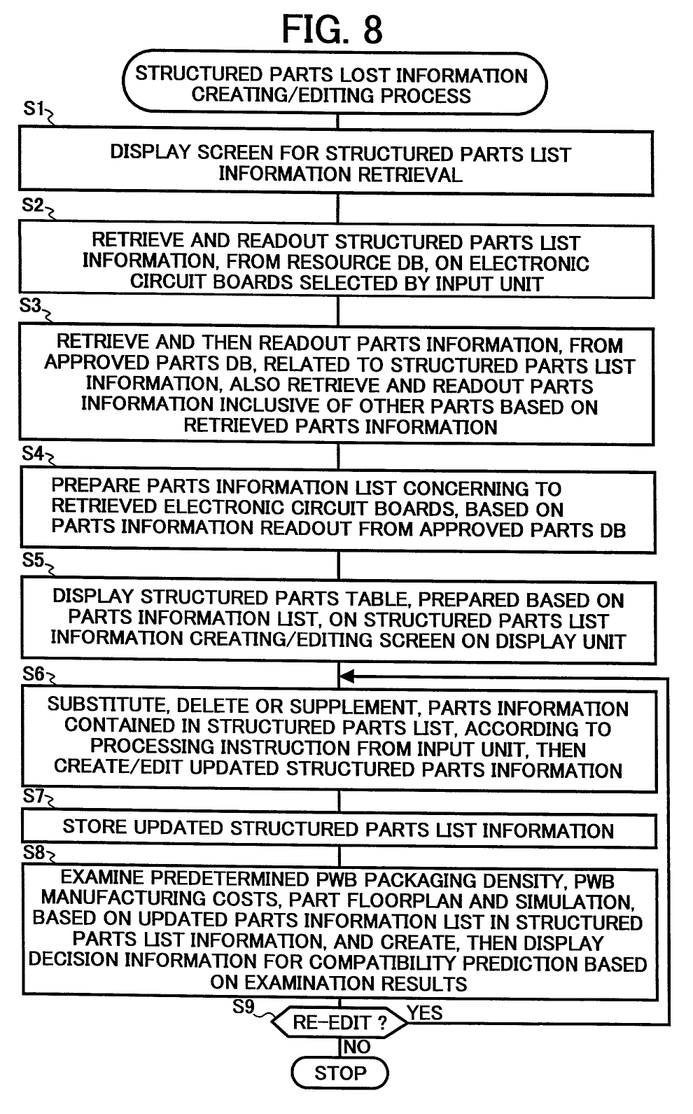

FIG. 8 includes a flow chart illustrating the structured parts list creating/editing process steps which are carried out by the structured parts list creating/editing system of FIG. 2.

Referring to FIG. 8, in Step 1 of the creating/editing process steps, the resource parts list creating/editing unit 3 operates to display a screen on the display for the structured parts list information retrieval.

The process proceeds to Step 2. In Step 2, the unit 3 operates to retrieve, from the resource DB 1, the information on electronic circuit boards which corresponds to certain keywords (or retrieval information) input from the input unit; display a table containing all pieces of retrieval information for the applicable electronic circuit boards, and readout structured parts list information related to the electronic circuit boards specifically selected by the input unit.

Subsequently, the process proceeds to Step 3. In Step 3, the unit 3 operates to retrieve, from the approved parts DB 2, parts information related to the thus readout structured parts list information; and retrieve readout parts information inclusive of other corresponding parts based on respective pieces of retrieved parts information (for example, function information).

The process then proceeds to Step 4. In Step 4, a parts information list is prepared concerning to the above retrieved electronic circuit boards, based on the respective pieces of parts information readout from the approved parts DB 2.

Subsequently, in Step 5, a structured parts list is displayed, including parts information concerning to the parts used during manufacturing steps, on the structured parts list information creating/editing screen on the display unit, also the unit 3 enables to refer to parts information concerning to various other parts.

Further, in Step 6, the unit 3 carries out the operation steps for creating/editing the structured parts list information such as, substituting the piece of the parts information, contained in the structured parts list, of certain specified parts with the information for other parts, having comparable functions; deleting the piece of the parts information, contained in the structured parts list, of a certain specified part; and supplementing parts information of other new parts.

The process then proceeds to Step 7. In Step 7, the unit 3 instructs to store, into the storage unit, updated structured parts list information which is created/edited on the basis of the thus prepared structured parts list.

Subsequently in Step 8, the output unit 7 operates, based on the updated parts information list, to examine several predetermined items such as, for example, printed-wiring board (PWB) packaging density, PWB manufacturing cost, parts floorplan, and simulation (circuit operation verification); and prepare decision information for compatibility prediction based on the results from the above examination, then instructs to display both the thus prepared decision information and the results from the above examination.

The process then proceeds to Step 9. In Step 9, an inquiry is made whether an instruction for re-edition is detected. If the response to the inquiry is affirmative, the process returns to Steep 6 to re-edit the structured parts list information, examines the above noted several items, and instructs to display the examination results. In contrast, if the response to the inquiry is negative, it is determined that the parts information list is completed, and the process ends.

There exemplified herein below are working screens on the display and working operations therewith during the creating/editing process steps of the structured parts list information.

FIG. 5 illustrates a retrieval screen on the display during the creating/editing process steps of the structured parts list information.

Referring to FIG. 5, when a keyword in the retrieval key input column 10 is selected during the process steps, corresponding to a certain presently desired item among various items such as unit or part class, PCB name, manufacturing location, PCB part number, part name (part number), and model status (model number), there displayed in retrieval result display column 11 is a table containing the portions of retrieval information from the resource DB 1 concerning to corresponding electronic circuit boards. In addition, more detailed information is displayed in retrieval result display column 12, concerning to a certain electronic circuit board selected among the boards in the table.

FIG. 6 illustrates a structured parts list creating/editing screen on the display during the structured parts list creating/editing process steps.

Referring to FIG. 6, when a desired electronic circuit board is selected during the process steps among the boards retrieved as descried just above, and when a resource input instruction is input, parts information concerning to the electronic circuit board corresponding to those presently selected is retrieved from the approved parts DB 2 based on the structured parts list information of the above selected electronic circuit board, and the resulting parts information is displayed in parts information list column 13 on the display.

FIG. 7 illustrates another structured parts list creating/editing screen on the display during the structured parts list creating/editing process steps.

Referring to FIG. 7, when substitution processing from some of the parts to others is intended in the parts information list column 13, the substitution step is carried out by first selecting the parts to be substituted in the column 13, then instructing to refer to those having comparable functions. The results containing the information on the retrieved parts having comparable functions are additionally displayed in the column 13 next to the lines previously displayed. Subsequently, by selecting parts among those in the thus updated list, the substitution is carried out from the parts to be substituted to those selected as above.

Also, when supplementing process of new parts is intended, supplementing steps are carried out, as shown in FIG. 7, by instructing the supplementing steps of parts information (indicated by the arrow 14 in FIG. 7) concerning to the retrieved parts based on, for example, the current price (part price). According to the instruction, the above parts information is subsequently supplemented into the parts information list column 13. In addition, several pieces of the information in the list 13 may also be deleted in a similar manner.

As described herein above, based on the structured parts list information concerning to previously manufactured electronic circuit boards, updated structured parts list information is thus creating/edited after incorporating new capabilities, stored into the storage unit 6, examined concerning to several items, and determined following the aforementioned compatibility prediction, to subsequently be transferred to the succeeding manufacturing steps of the electronic circuit board fabrication.

Incidentally, the structured parts list creating/editing system is detailed so far primarily on its functional unit specifically related to the embodiment disclosed herein. It may be added, however, that other functional units may additionally be provided. For example, the units may be ones used in circuit designing such as designing, drawing, verifying and other similar functional units.

With the units having above described capabilities, and based on the thus prepared updated structured parts list information of electronic circuit boards, various process steps of circuit design becomes feasible including designing, drawing, and verifying, by means of a single system.

In addition, the structured parts list creating/editing system may further be able to carry out parts selection process steps more efficiently.

Namely, in the structured parts list creating/editing system, the resource DB 1 and approved parts DB 2 are interconnected by way of communication network such as, for example, the public telephone network or optical communication network, and further incorporating a number of other structured parts list creating/editing systems to be mutually linked by way of the communication network so that for the resource DB 1 and approved parts DB 2 be able to be referred each other and from the other structured parts list creating/editing systems as well. Since the construction of the above noted structured parts list creating/editing systems with the resource DB 1 and approved parts DB 2 through the network enables for these data bases be utilized by a number of users, as common data bases, this may considerably facilitate efficient process steps of selecting most suitable parts for the electronic circuit boards presently concerned.

Although there is detailed so far in the present embodiment, on a rather specific system construction of the creating/editing system in exclusive use for the above noted structured parts list creating/editing process steps, the above noted creating/editing process steps may also be carried out with a information processing apparatus such as, for example, a conventional personal computer, in which programs for the above noted process steps is installed in a storage medium such as, for example, a floppy disk and optical disk, then executed by a control unit in the information processing apparatus (functional units embodied in the apparatus such as CPU, ROM, RAM and other similar devices).

Namely, the above noted storage media such as floppy disk and optical disk serve as storage means to store various programs of processing steps to subsequently be utilized for executing the programs, having capabilities comparable to those with storage unit in the aforementioned structured parts list creating/editing system.

These comparable capabilities or functions are (1) structured parts list information storage functions capable of storing a plurality of pieces of information of structured parts list constituted of various kinds of electronic components, (2) parts information storage functions capable of storing a plurality of pieces of parts information concerning to identification, function, manufacturer, size, shape, future prospect, price and approval data regarding, for example, whether the part of interest is approved for present use, (3) resource parts list creating/editing functions capable of preparing a parts information list by first retrieving the parts information of respective parts in the structured parts list information, which is stored from parts information, then preparing a parts information list for respective parts included in the structured parts list information, (4) structured parts list information creating/editing functions capable of creating/editing an updated structured parts list information based on the parts information list prepared as described above, and (5) functions of examining several predetermined items based on the updated structured parts list information created/edited by the structured parts list information /editing functions, and preparing and then outputting decision information for compatibility prediction prepared based on the results from the above examination.

Subsequently, a control unit in the above noted information processing apparatus such as a conventional personal computer executes, based on the parts information list prepared above, various processing steps such as storing a plurality of pieces of information on structured parts list, storing a plurality of pieces of parts information concerning to identification, function, manufacturer, size, shape, future prospect, price and approval data regarding whether the part of interest is approved for present use; preparing a part information list by first retrieving the parts information of respective parts in the structured parts list information, then preparing a parts information list for respective parts included in the structured parts list information; creating/editing an updated structured parts list information based on the parts information list prepared as above; and examining several predetermined items based on the updated structured parts list information and preparing, then outputting decision information for compatibility prediction prepared based on the results from the above examination.

According to the embodiment disclosed herein, it becomes not mandatory, for respective parts to be referred one by one to either a catalogue or data sheet provided by the manufacturer during creating/editing steps of new structured parts list information concerning to the electronic circuit boards. Therefore, workloads of reference and/or retrieval works may considerably be reduced.

In addition, since the parts information to be presently referred is generally the latest for the parts and aforementioned status information (or approval information) especially useful in decision making steps can also be referred, structured parts list information concerning to new electronic circuit boards can be prepared efficiently in relatively short period of time.

Through the above updated structured parts list information, undesirable effects can be avoided, which are caused by possible undue situations such as, for example, changes in specification, shape and/or price, or discontinuation of manufacturing of the parts, which are unnoticed up to the point of, or after creating the parts information. In such cases, recreating structured parts list information, parts substitution to other ones, or even the change in the initial design may otherwise be necessitated. Namely, by providing the updated structured parts list information, unfavorable situations against efficient electronic circuit board manufacturing and concurrent undue waste of manufacturing costs can therefore be alleviated.

Further, once an updated structured parts list information is created, survey results on predetermined items such as PWB packaging density, PWB manufacturing cost, parts floorplan, and simulation (circuit operation verification), and also compatibility prediction based on the results from the above examination, includded therein may be referred, inconvenience, if any, and/or feasibility for the electronic circuit board can be estimated without delay. This facilitates, therefore, to considerably reduce the workload for designing circuit boards having desirable characteristics within certain predetermined costs.

Still further, since the updated structured parts list information can quickly be transferred to, or shared by, various processes, succeeding steps from development through manufacturing processes can proceed smoothly, thereby enabling new products be input timely into the market.

Incidentally, although the creating/editing process steps according to the present embodiment are detailed on structured parts list information based on parts information concerning to electronic circuit boards, these process steps may also be adopted to other apparatus such as, for example, machine tools and control apparatus in a similar manner.

Namely, this may be carried out by storing structured parts list information of various machine tools and other similar apparatus into a resource DB, storing parts information of various machine tools and other similar apparatus into an approved parts DB, retrieving the parts information of corresponding parts by the resource parts list /editing unit from the resource DB based on the structured parts list information retrieved from the resource DB, then preparing a parts information list; by the compatibility prediction information output unit 7, carrying out the survey on predetermined items such as PWB packaging density, PWB manufacturing cost, parts floorplan, and simulation (circuit operation verification), to subsequently output compatibility prediction prepared based on the survey, together with survey results.

In still another embodiment, another structured parts list information creating/editing system has an overall circuit construction as illustrate in FIG. 2, which will be detailed herein below.

It is noted that, in the following description, the structure and process steps common to those included in the previous, second embodiment are not described so much in detail, since they obscure the present disclosure in unnecessary detail.

The structured parts list creating/editing system is an information processing system such as, for example, a personal computer including at least CPU, PROM, RAM and other similar devices.

This system is configured during the designing electronic circuits to carry out creating/editing processing operations onto updated information on structured parts list with respect to previously stored information of parts and structured parts list information of electronic circuit boards.

The system is also configured to survey predetermined verification items (including the function for verifying the feasibility of desired circuit operations and functions) based on a parts information list of the structured parts list information, then output decision information, based on results from the survey, to be utilized for goodness-of-fit prediction regarding whether present structured parts list is compatible with various conditions determined during the circuit design process steps.

A design engineer may also re-edit obtained structured parts list information based on the decision information.

The thus prepared created/edited/re-edited structured parts list information may be utilized throughout succeeding process steps of circuit board manufacturing, such as designing circuit diagrams using component symbols, and creating detailed circuit drawings, preparing parts lists and circuit diagrams to be utilized during manufacturing steps.

Referring to FIG. 2, a structured parts list creating/editing system according to the present embodiment is provided with several units such as such as a resource DB 1, approved parts DB 2, resource parts list creating/editing unit 3, input unit 4, display unit 5 and storage unit 6, and compatibility prediction information output unit 7, in similar manner to the second embodiment.

The resource DB 1 consists primarily a storage unit including at least hard disks and/or optical disks. The resource DB 1 is configured to operate as a data base which stores a plurality of pieces of structured parts list information related to both previously designed electronic circuit boards and known electronic circuit boards. In addition, to each of the above structured parts list information of the electronic circuit boards, retrieval information is further provided as a keyword.

In addition, the resource DB 1 is configured to store retrieval information in a predetermined format appropriate to be capable to be readout based on the retrieval information.

The retrieval information includes a plurality of pieces of information regarding function, name, usage, manufacturer and/or user. Also, the parts information consists of name, manufacturer, model number, part number, quantity, unit price, and other similar part data, for the parts such as resistors, capacitors, ICs and other similar devices, which are respectively incorporated into electronic circuit boards.

Based on the retrieval information, the retrieval of electronic circuit board information from the resource DB 1 becomes feasible according to required functions and use.

In addition, based on the structured parts list information retrieved from the resource DB 1, the retrieval also becomes feasible from approved parts DB 2 regarding parts information for various parts used during manufacturing steps.

The resource DB 2 also consists primarily of a storage unit including at least hard disks and/or optical disks. This resource DB 2 is configured to operate as a data base (parts information storage means) which register a plurality of pieces of parts information.

The resource DB 2 is configured to store in a predetermined format that is appropriate to readout retrieval information based on respective pieces of parts information. Further, respective parts information may also be stored in a predetermined format suitable for referring to a specific item in the information concerning to other components having functions comparable with the one presently retrieved, for example.

The above parts information includes a plurality of pieces of information of respective parts regarding identification, function, name of manufacturer, shape, prospect, price and/or approval data, which are created/edited in a similar manner to those described earlier in the previous embodiments.

The resource parts list creating/editing unit 3 assumes the overall control of the structured parts list creating/editing system. The creating/editing unit 3 is thus configured to retrieve structured parts list information concerning to electronic circuit boards, which is stored in the resource DB 1; readout the thus retrieved structured parts list information; from the approved parts DB 2, retrieve and then readout the parts information on respective parts corresponding to the above retrieved structured parts list information (including parts information during electronic board manufacturing process steps as well as presently updated parts information in inclusive of other components having functions comparable with the one presently retrieved); and prepare a parts information list based on the above obtained parts information.

The creating/editing unit 3 is also configured to achieve processing operation for the parts information list be displayed on a display unit 5 for creating/editing the structured parts list information based on the parts information list; substitute, delete and/or supplement the content of the parts information in the parts information list according to operation instruction input from an input unit 4, create/edit the structured parts list information, write the structured parts list information into the storage unit 6, thereby achieving the registration of the information, and output the thus prepared updated parts information list to the compatibility prediction information output unit 7.

The input unit 4 consists primarily of input devices such as, for example, a keyboard and mouse. The input unit 4 is configured to input a variety of input instructions for a user to retrieve, from the resource DB 1, the structured parts list information regarding the desired electronic circuit boards, based on a screen for retrieval displayed on the display unit 5; to create/edit/re-edit an updated structured parts list based on the structured parts list displayed on the display unit 5, to input instruction information for either carrying out the survey of a plurality of the predetermined kind of items or outputting decision information for compatibility prediction based on results of the survey.

The display unit 5 consists primarily of display devices such as, for example, CRT and LCD. The display unit 5 is configured to display work sheet screens on the display, structured parts lists, other similar screens during creating/editing/re-editing steps of the work sheets and structured parts list information, results from the survey, decision information for compatibility prediction, and other similar piece of information.

The storage unit 6 consists primarily of storage devices such as, for example, hard disks and optical disks. The storage unit 6 is configured to store the structured parts list information prepared as above.

The compatibility prediction information output unit 7 is configured to carry out several processing operations, which follows. Namely, based on the parts information list created/edited/re-edited by the resource parts list creating/editing unit 3, the output unit 7 examines several items such as, for example, PWB packaging density, PWB manufacturing cost, parts floorplan, and simulation (circuit operation verification); and prepares decision information for compatibility prediction based on the results from the above examination, then instructs to display both the thus prepared decision information and the results from the above examination on the display unit 5.

In regard to the examination item on the PWB packaging density, the output unit 7 examines the packaging density of the parts on circuit boards, based on the parts information list in structured parts list information; and prepares decision information for predicting the compatibility with predetermined requirements (feasibility, for example) i.e., relative readiness or difficulty in packaging process based on the results from the examination, to subsequently display the thus prepared results.

In regard to the PWB manufacturing cost, the output unit 7 examines manufacturing costs of circuit boards, on which electronic parts are to be mounted, based on the parts information list in structured parts list information; and prepares decision information for predicting the compatibility with predetermined requirements (predetermined manufacturing costs) based on the results from the examination, to subsequently display thus obtained results.

In regard to the parts floorplan, the output unit 7 examines parts arrangements on circuit boards, and prepares decision information for predicting the compatibility with predetermined requirements (feasibility of parts arrangements into a predetermined chip area) based on the results from the examination, to subsequently display obtained results.

In regard to the simulation (circuit operation verification), the output unit 7 carries out the operation verification for either the whole, or the portions of the circuits on the PWB. For the portions of PWB circuits, the simulation steps are carried out by storing a variety of pieces of simulation model information formed beforehand based on technical requirements foreseen for the circuit board fabrication, carrying out simulation steps using various parameters corresponding to the models selected from the above simulation models, and then creating prediction information based on the simulation results.

In addition, decision information on compatibility with predetermined conditions (required for circuit operation) is prepared, to subsequently be displayed.

The resource DB 1 and approved parts DB 2 assume the similar functions to those described earlier in the first embodiment.

The resource parts list creating/editing unit 3 assumes the overall control of the structured parts list creating/editing system in similar manner again to that described earlier in the first embodiment. Namely, the resource parts list creating/editing unit 3 serves as the means to prepare a parts information list and to create/edit the structured parts list information, in which the former means to prepare a parts information list operates to retrieve the parts information of respective parts in the structured parts list information, which is stored from parts information, and to prepare a parts information list for respective parts included in the structured parts list information. The latter means to create/edit the structured parts list information operates to create/edit updated structured parts list information based on the parts information list prepared by the former means to prepare a parts information list, as described above.

The compatibility prediction information output unit 7 serves to carry out several functions such as storing a variety of pieces of simulation model information formed beforehand based on technical requirements foreseen for the circuit board fabrication, carrying out simulation steps using various parameters corresponding to the models selected from the above simulation models, and generating and then displaying decision prediction information on compatibility with predetermined conditions based on the simulation results.

The resource DB 1 in the present embodiment has a similar data format to that described earlier in the previous embodiments (FIGS. 3A, 3B and 3C).

There detailed herein below are structured parts list creating/editing process steps which are carried out by the structured parts list creating/editing system disclosed herein.

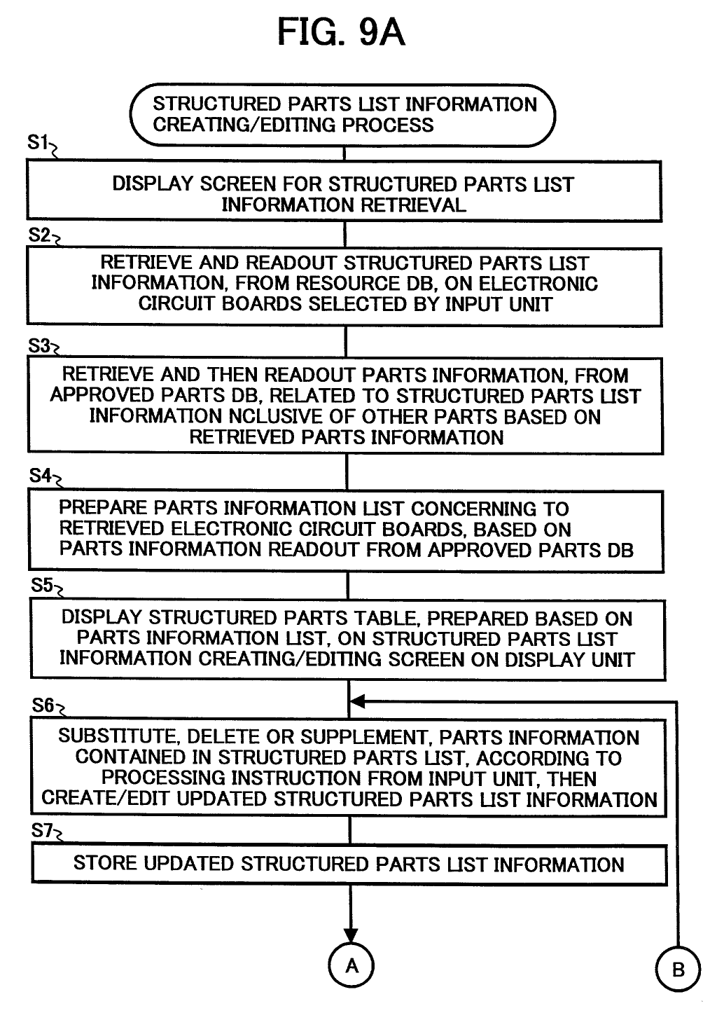

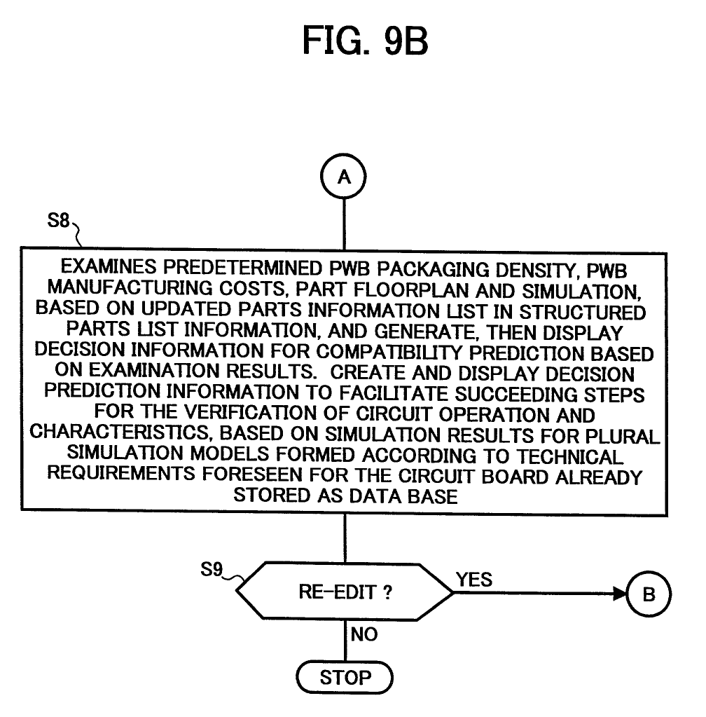

FIG. 9 includes a flow chart illustrating the structured parts list creating/editing process steps which are carried out by the structured parts list creating/editing system of FIG. 2.

Referring to FIG. 9, in Step 1 of the creating/editing process steps, the resource parts list creating/editing unit 3 operates to display a screen on the display for the structured parts list information retrieval.

The process proceeds to Step 2. In Step 2, the unit 3 operates to retrieve, from the resource DB 1, the information on electronic circuit boards which corresponds to certain keywords (or retrieval information) input from the input unit; display a table containing all pieces of retrieval information for the applicable electronic circuit boards, and readout structured parts list information related to the electronic circuit boards specifically selected by the input unit.

Subsequently, the process proceeds to Step 3. In Step 3, the unit 3 operates to retrieve, from the approved parts DB 2, parts information related to the thus readout structured parts list information; and retrieve readout parts information inclusive of other corresponding parts based on respective pieces of retrieved parts information (for example, function information).

The process then proceeds to Step 4. In Step 4, a parts information list is prepared concerning to the above retrieved electronic circuit boards, based on the respective pieces of parts information readout from the approved parts DB 2.

Subsequently, in Step 5, a structured parts list is displayed, including parts information concerning to the parts used during manufacturing steps, on the structured parts list information creating/editing screen on the display unit, also the unit 3 enables to refer to parts information concerning to various other parts.

Further, in Step 6, the unit 3 carries out the operation steps for creating/editing the structured parts list information such as, substituting the piece of the parts information, contained in the structured parts list, of certain specified parts with the information for other parts, having comparable functions; deleting the piece of the parts information, contained in the structured parts list, of a certain specified part; and supplementing parts information of other new parts.

The process then proceeds to Step 7. In Step 7, the unit 3 instructs to store, into the storage unit, updated structured parts list information which is created/edited on the basis of the thus prepared structured parts list.

Subsequently in Step 8, the output unit 7 operates, based on the updated parts information list, to examine several predetermined items such as, for example, PWB packaging density, PWB manufacturing cost, parts floorplan, and simulation; and prepare decision information for compatibility prediction based on the results from the above examination, then instructs to display both the thus prepared decision information and the results from the above examination.

In addition, according to an input instruction by the input unit, decision prediction information is created and displayed to facilitate succeeding steps for the verification of circuit operation and characteristics. The decision prediction information herein is created as described earlier, based on the results from simulation steps which are carried out based on the variety of pieces of simulation model information which are created on the basis of technical requirements foreseen for the circuit board already stored as the data base.

The process then proceeds to Step 9. In Step 9, an inquiry is made whether an instruction for re-edition is detected. If the response to the inquiry is affirmative, the process returns to Steep 6 to re-edit the structured parts list information, examines the above noted several items, and instructs to display the examination results. In contrast, if the response to the inquiry is negative, it is determined that the parts information list is completed, and the process ends.

There exemplified herein below are working screens on the display and working operations therewith during the creating/editing process steps of the structured parts list information.

FIG. 5 illustrates a retrieval screen on the display during the creating/editing process steps of the structured parts list information.

Referring to FIG. 5, when a keyword in the retrieval key input column 10 is selected during the process steps, corresponding to a certain presently desired item among various items such as unit or part class, PCB name, manufacturing location, PCB part number, part name (part number), and model status (model number), there displayed in retrieval result display column 11 is a table containing the portions of retrieval information from the resource DB 1 concerning to corresponding electronic circuit boards. In addition, more detailed information is displayed in retrieval result display column 12, concerning to a certain electronic circuit board selected among the boards in the table.

FIG. 6 illustrates a structured parts list creating/editing screen on the display during the structured parts list creating/editing process steps.

Referring to FIG. 6, when a desired electronic circuit board is selected during the process steps among the boards retrieved as descried just above, and when a resource input instruction is input, parts information concerning to the electronic circuit board corresponding to those presently selected is retrieved from the approved parts DB 2 based on the structured parts list information of the above selected electronic circuit board, and the resulting parts information is displayed in parts information list column 13 on the display.

FIG. 7 illustrates another structured parts list creating/editing screen on the display during the structured parts list creating/editing process steps.

Referring to FIG. 7, when substitution processing from some of the parts to others is intended in the parts information list column 13, the substitution step is carried out by first selecting the parts to be substituted in the column 13, then instructing to refer to those having comparable functions. The results containing the information on the retrieved parts having comparable functions are additionally displayed in the column 13 next to the lines previously displayed. Subsequently, by selecting parts among those in the thus updated list, the substitution is carried out from the parts to be substituted to those selected as above.

Also, when supplementing process of new parts is intended, supplementing steps are carried out, as shown in FIG. 7, by instructing the supplementing steps of parts information (indicated by the arrow 14 in FIG. 7) concerning to the retrieved parts based on, for example, the current price (part price). According to the instruction, the above parts information is subsequently supplemented into the parts information list column 13. In addition, several pieces of the information in the list 13 may also be deleted in a similar manner.

Following the preparation of the parts information list, operation verification steps are carried out for the portions of the circuits through processing the aforementioned simulation items, which follows.

First, a time to finish, which is to be input into a waveform simulator engine, is adjusted for generating the waveform. The time to finish is automatically set when the operation frequency of a driver changes. In addition, the time may also be adjusted manually.

In addition, a simulation grade is adjusted in a trade-off fashion between the simulation period of time. That is, more time is need with the increase in accuracy of the simulation.

Subsequently, a desired model is selected through inputting operations of simulation model parametrs among a model simulation net, or a variety of pieces of simulation model information formed beforehand based on technical requirements foreseen for the circuit board fabrication, and then input parameters for the presently selected model.

Simulation steps are then carried out, and the resulting waveform obtained from the simulation is then displayed through waveform display processing.

When an arbitrary point on the waveform is selected, a waveform information dialogue is displayed together with voltage and time for the selected node for the waveform. In addition, the difference in voltage from that expected at a certain time may also be displayed.

Further, through spectral display processing, spectral forms obtained by spectral analysis processing for respective transfer lines may also be displayed.

In addition, based on the thus obtained simulation results, circuit wiring rules are formed for the presently simulated circuit through support processing for creating layout rule, and layout rule information is then filed.

As described herein above, based on the structured parts list information concerning to previously manufactured electronic circuit boards, updated structured parts list information is thus created/edited after incorporating new capabilities, stored into the storage unit 6, examined concerning to several items, and determined following the aforementioned compatibility prediction, to subsequently be transferred to the succeeding manufacturing steps of the electronic circuit board fabrication.

Incidentally, the structured parts list creating/editing system is detailed so far primarily on its functional unit specifically related to the embodiment disclosed herein. It may be added, however, that other functional units may additionally be provided. For example, the units may be ones used in circuit designing such as designing, drawing, verifying and other similar functional units.

With the units having above described capabilities, and based on the thus prepared updated structured parts list information of electronic circuit boards, various process steps of circuit design becomes feasible including designing, drawing, and verifying, by means of a single system.

In addition, the structured parts list creating/editing system may further be able to carry out parts selection process steps more efficiently.

Namely, in the structured parts list creating/editing system, the resource DB 1 and approved parts DB 2 are interconnected by way of communication network such as, for example, the public telephone network or optical communication network, and further incorporating a number of other structured parts list creating/editing systems to be mutually linked by way of the communication network so that for the resource DB 1 and approved parts DB 2 be able to be referred each other and from the other structured parts list creating/editing systems as well. Since the construction of the above noted structured parts list creating/editing systems with the resource DB 1 and approved parts DB 2 through the network enables for these data bases be utilized by a number of users, as common data bases, this may considerably facilitate efficient process steps of selecting most suitable parts for the electronic circuit boards presently concerned.

Although there is detailed so far in the present embodiment, on a rather specific system construction of the creating/editing system in exclusive use for the above noted structured parts list creating/editing process steps, the above noted creating/editing process steps may also be carried out with an information processing apparatus such as, for example, a conventional personal computer, in which programs for the above noted process steps is installed in a storage medium such as, for example, a floppy disk and optical disk, then executed by a control unit in the information processing apparatus (functional units embodied in the apparatus such as CPU, ROM, RAM and other similar devices).

Namely, the above noted storage media such as floppy disk and optical disk serve as storage means to store various programs of processing steps to subsequently be utilized for executing the programs, having the following capabilities (1) through (5) comparable to those with storage unit in the aforementioned structured parts list creating/editing system.

These comparable capabilities or functions are (1) structured parts list information storage functions capable of storing a plurality of pieces of information of structured parts list constituted of various kinds of electronic components, (2) parts information storage functions capable of storing a plurality of pieces of parts information concerning to identification, function, manufacturer, size, shape, future prospect, price and approval data regarding, for example, whether the part of interest is approved for present use, (3) resource parts list creating/editing functions capable of preparing a parts information list by first retrieving the parts information of respective parts in the structured parts list information, which is stored from parts information, then preparing a parts information list for respective parts included in the structured parts list information, (4) structured parts list information creating/editing functions capable of creating/editing an updated structured parts list information based on the parts information list prepared as described above, and (5) functions of storing a variety of pieces of simulation model information formed beforehand based on technical requirements foreseen for the present component (circuit), carrying out simulation steps using various parameters corresponding to the models selected from the above simulation models, and generating and displaying decision prediction information on compatibility with predetermined conditions based on the simulation results.

Subsequently, a control unit in the above noted information processing apparatus such as a conventional personal computer executes, based on the parts information list prepared above, various processing steps such as storing a plurality of pieces of information on structured parts list, storing a plurality of pieces of parts information concerning to identification, function, manufacturer, size, shape, future prospect, price and approval data regarding whether the part of interest is approved for present use; preparing a parts information list by first retrieving the parts information of respective parts in the structured parts list information, then preparing a parts information list for respective parts included in the structured parts list information; creating/editing an updated structured parts list information based on the parts information list prepared as above; and examining several predetermined items based on the updated structured parts list information and preparing, then outputting decision information for compatibility prediction prepared based on the results from the above examination.

In addition, the above control unit also executes further processing steps such as storing a variety of pieces of simulation model information formed beforehand based on technical requirements foreseen for the present component (circuit), carrying out simulation steps using various parameters corresponding to the models selected from the above simulation models, and generating and displaying decision prediction information on compatibility with predetermined conditions based on the simulation results.

According to the embodiment disclosed herein, it becomes not mandatory, for respective parts to be referred one by one to either a catalogue or data sheet provided by the manufacturer during creating/editing steps of new structured parts list information concerning to the electronic circuit boards. Therefore, workloads of reference and/or retrieval works may considerably be reduced.

In addition, since the parts information to be presently referred is generally the latest for the parts and aforementioned status information (or approval information) especially useful in decision making steps can also be referred, structured parts list information concerning to new electronic circuit boards can be prepared efficiently in relatively short period of time.

Through the above updated structured parts list information, undesirable effects can be avoided, which are caused by possible undue situations such as, for example, changes in specification, shape and/or price, or discontinuation of manufacturing of the parts, which are unnoticed up to the point of, or after creating the parts information.

In such cases, the recreating structured parts list information, parts substitution to other ones, or even the change in the initial design may otherwise be necessitated. Namely, by providing the updated structured parts list information, therefore, unfavorable situations against efficient electronic circuit board manufacturing and concurrent undue waste of manufacturing costs can therefore be alleviated.

Further, once an updated structured parts list information is created, survey results on predetermined items such as PWB packaging density, PWB manufacturing cost, parts floorplan, and simulation (circuit operation verification), and also compatibility prediction based on the results from the above examination, included therein may be referred, inconvenience, if any, and/or feasibility for the electronic circuit board can be estimated without delay. This facilitates, therefore, to reduce considerably the workload for designing circuit boards having desirable characteristics within certain predetermined costs.

Still further, since newly designed circuits may be verified for respective portions thereof with relative ease, operations and characteristics of desired circuits can be examined quite easily without redesigning the circuits from the start.

Since the updated structured parts list information can quickly be transferred to, or shared by, various processes, succeeding steps from development through manufacturing processes can proceed smoothly, thereby enabling new products be input timely into the market.

Incidentally, although the creating/editing process steps according to the present embodiment are detailed on structured parts list information based on parts information concerning to electronic circuit boards, these process steps may also be adopted to other apparatus such as, for example, machine tools and control apparatus in a similar manner.

Namely, this may be carried out by storing structured parts list information of various machine tools and other similar apparatus into a resource DB, storing parts information of various machine tools and other similar apparatus into an approved parts DB, retrieving the parts information of corresponding parts by the resource parts list creating/editing unit from the resource DB based on the structured parts list information retrieved from the resource DB, then preparing a parts information list; by the compatibility prediction information output unit 7, carrying out the survey on predetermined items such as PWB packaging density, PWB manufacturing cost, parts floorplan, and simulation (circuit operation verification), to subsequently output compatibility prediction prepared based on the survey, together with survey results.

In another embodiment, another structured parts list information creating/editing system also has an overall circuit construction as illustrate in FIG. 2, which will be detailed herein below.

It is noted in the following description, that the structure and process steps common to those included in the previous embodiments are not described so much in detail, since they obscure the present disclosure in unnecessary detail.

The structured parts list creating/editing system is an information processing system such as, for example, a personal computer including at least CPU, PROM, RAM and other similar devices.

This system is configured during the designing electronic circuits to carry out creating/editing processing operations onto updated information on structured parts list with respect to previously stored information of parts and structured parts list information of electronic circuit boards.

The system is also configured to survey predetermined verification items (including the function for verifying the feasibility of desired circuit operations and functions) based on a parts information list of the structured parts list information, then output decision information, based on results from the survey, to be utilized for goodness-of-fit prediction regarding whether present structured parts list is compatible with various conditions determined during the circuit design process steps.

A design engineer may also re-edit obtained structured parts list information based on the decision information.

The created/edited/re-edited structured parts list information may be utilized throughout succeeding process steps of circuit board manufacturing, such as designing circuit diagrams using component symbols, and creating detailed circuit drawings, preparing parts lists and circuit diagrams to be utilized during manufacturing steps.

Referring to FIG. 2, a structured parts list creating/editing system according to the present embodiment is provided with several units such as such as a resource DB 1, approved parts DB 2, resource part list creating/editing unit 3, input unit 4, display unit 5 and storage unit 6, and compatibility prediction information output unit 7, in similar manner to the previous embodiments.

The resource DB 1 consists primarily a storage unit including at least hard disks and/or optical disks. The resource DB 1 is configured to operate as a data base which stores a plurality of pieces of structured parts list information related to both previously designed electronic circuit boards and known electronic circuit boards. In addition, to each of the above structured parts list information of the electronic circuit boards, retrieval information is further provided as a keyword.

In addition, the resource DB 1 is configured to store retrieval information in a predetermined format appropriate to be capable to be readout based on the retrieval information.

The retrieval information includes a plurality of pieces of information regarding function, name, usage, manufacturer and/or user. Also, the parts information consists of name, manufacturer, model number, part number, quantity, unit price, and other similar part data, for the parts such as resistors, capacitors, ICs and other similar devices, which are respectively incorporated into electronic circuit boards.

Based on the retrieval information, the retrieval of electronic circuit board information from the resource DB 1 becomes feasible according to required functions and use.

In addition, based on the structured parts list information retrieved from the resource DB 1, the retrieval also becomes feasible from approved parts DB 2 regarding parts information for various parts used during manufacturing steps.

The resource DB 2 also consists primarily of a storage unit including at least hard disks and/or optical disks. This resource DB 2 is configured to operate as a data base (parts information storage means) which register a plurality of pieces of parts information.

The resource DB 2 is configured to store in a predetermined format that is appropriate to readout retrieval information based on respective pieces of parts information. Further, respective parts information may also be stored in a predetermined format suitable for referring to a specific item in the information concerning to other components having functions comparable with the one presently retrieved, for example.

The above parts information includes a plurality of pieces of information of respective parts regarding identification, function, name of manufacturer, shape, prospect, price and/or approval data, which are created/edited in a similar manner to those described earlier in the previous embodiments.

The resource parts list creating/editing unit 3 assumes the overall control of the structured parts list creating/editing system.

The creating/editing unit 3 is thus configured to retrieve structured parts list information concerning to electronic circuit boards, which is stored in the resource DB 1; readout the thus retrieved structured parts list information; from the approved parts DB 2, retrieve and then readout the parts information on respective parts corresponding to the above retrieved structured parts list information (including parts information during electronic board manufacturing process steps as well as presently updated parts information in inclusive of other components having functions comparable with the one presently retrieved); and prepare a parts information list based on the above obtained parts information.

The creating/editing unit 3 is also configured to achieve processing operation for the parts information list be displayed on a display unit 5 for creating/editing the structured parts list information based on the parts information list; substitute, delete and/or supplement the content of the parts information in the parts information list according to operation instruction input from an input unit 4, create/edit the structured parts list information, write the structured parts list information into the storage unit 6, thereby achieving the registration of the information, and output the thus prepared updated parts information list to the compatibility prediction information output unit 7.

The input unit 4 consists primarily of input devices such as, for example, a keyboard and mouse. The input unit 4 is configured to input a variety of input instructions for a user to retrieve, from the resource DB 1, the structured parts list information regarding the desired electronic circuit boards, based on a screen for retrieval displayed on the display unit 5; to create/edit/re-edit an updated structured parts list based on the structured parts list displayed on the display unit 5, to input instruction information for either carrying out the survey of a plurality of the predetermined kind of items or outputting decision information for compatibility prediction based on results of the survey.

The display unit 5 consists primarily of display devices such as, for example, CRT and LCD. The display unit 5 is configured to display work sheet screens on the display, structured parts lists, other similar screens during creating/editing/re-editing steps of the work sheets and structured parts list information, results from the survey, decision information for compatibility prediction, and other similar piece of information.

The storage unit 6 consists primarily of storage devices such as, for example, hard disks and optical disks. The storage unit 6 is configured to store the structured parts list information prepared as above.

The compatibility prediction information output unit 7 is configured to carry out several processing operations, which follows. Namely, based on the parts information list created/edited/re-edited by the resource parts list creating/editing unit 3, the output unit 7 examines several items such as, for example, PWB packaging density, PWB manufacturing cost, parts floorplan, and simulation (circuit operation verification); and prepares decision information for compatibility prediction based on the results from the above examination, then instructs to display both the thus prepared decision information and the results from the above examination on the display unit 5.

In regard to the examination item on the PWB packaging density, the output unit 7 examines the packaging density of the part on circuit boards, based on the parts information list in structured parts list information; and prepare decision information for predicting the compatibility with predetermined requirements (feasibility, for example) i.e., relative readiness or difficulty in packaging process based on the results from the examination, to subsequently display the thus prepared results.

In regard to the PWB manufacturing cost, the output unit 7 examines manufacturing costs of circuit boards, on which electronic parts are to be mounted, based on the parts information list in structured parts list information; and prepares decision information for predicting the compatibility with predetermined requirements (predetermined manufacturing costs) based on the results from the examination, to subsequently display thus obtained results.

In regard to the parts floorplan, the output unit 7 examines parts layouts on circuit boards, and prepares decision information for predicting the compatibility with predetermined restrictions (feasibility of parts layouts into a predetermined chip area) based on the results from the examination, to subsequently display thus obtained results.

The above noted restrictions include those concerning to blocked area for the layout, part height, connector position, part location, pattern routing, and equal-trace-length requirements.

In regard to the simulation (circuit operation verification), the output unit 7 carries out the operation verification for either the whole, or the portions of the circuits on the PWB. For the portions of PWB circuits, the simulation steps are carried out by storing a variety of pieces of simulation model information formed beforehand based on technical requirements foreseen for the circuit board fabrication, carrying out simulation steps using various parameters corresponding to the models selected from the above simulation models, and then creating prediction information based on the simulation results.

In addition, decision information on compatibility with predetermined conditions (required for circuit operation) is prepared, to subsequently be displayed.

The resource DB 1 and approved parts DB 2 assume similar functions to those described earlier in the first embodiment.

The resource parts list creating/editing unit 3 assumes the overall control of the structured parts list creating/editing system in similar manner again to that described earlier in the first embodiment. Namely, the resource parts list creating/editing unit 3 serves as the means to prepare a parts information list and to create/edit the structured parts list information, in which the former means to prepare a parts information list operates to retrieve the parts information of respective parts in the structured parts list information, which is stored from parts information, and to prepare a parts information list for respective parts included in the structured parts list information. The latter means to create/edit the structured parts list information operates to create and edit updated structured parts list information based on the parts information list prepared by the former means to prepare a parts information list, as described above.

In addition, the compatibility prediction information output unit 7 also serves as the means to estimate packaging densities for the layout with all components mounted on, or within desired layout area of the circuit board based on the updated created/edited parts information list in the structured parts list information, and to prepare decision information for compatibility prediction based on the results from the above estimation, then instructs to display the thus prepared decision information.

Further, the compatibility prediction information output unit 7 also serves as the means to perform the layout of all the components based on the updated created/edited parts information list in the structured parts list information together with predetermined several restrictions, and prepares decision information for compatibility prediction based on the results from the above layout, then instructs to display the thus prepared decision information.

The resource DB 1 in the present embodiment has a similar data format to that described earlier in the previous embodiments (FIGS. 3A, 3B and 3C).

There detailed herein below are structured parts list creating/editing process steps which are carried out by the structured parts list creating/editing system disclosed herein.

FIG. 8 includes a flow chart illustrating the structured parts list creating/editing process steps which are carried out by the structured parts list creating/editing system of FIG. 2.

Referring to FIG. 8, in the step of the creating/editing process, the resource parts list creating/editing unit 3 operates to display a screen on the display for the structured parts list information retrieval.

The process proceeds to Step 2. In Step 2, the unit 3 operates to retrieve, from the resource DB 1, the information on electronic circuit boards which corresponds to certain keywords (or retrieval information) input from the input unit; display a table containing all pieces of retrieval information for the applicable electronic circuit boards, and readout structured parts list information related to the electronic circuit boards specifically selected by the input unit.

Subsequently, the process proceeds to Step 3. In Step 3, the unit 3 operates to retrieve, from the approved parts DB 2, parts information related to the thus readout structured parts list information; and retrieve readout parts information inclusive of other corresponding parts based on respective pieces of retrieved parts information (for example, function information).

The process then proceeds to Step 4. In Step 4, a parts information list is prepared concerning to the above retrieved electronic circuit boards, based on the respective pieces of parts information readout from the approved parts DB 2.

Subsequently, in Step 5, a structured parts list is displayed, including parts information concerning to the parts used during manufacturing steps, on the structured parts list information creating/editing screen on the display unit, also the unit 3 enables to refer to parts information concerning to various other parts.

Further, in Step 6, the unit 3 carries out the operation steps for creating/editing the structured parts list information such as, substituting the piece of the parts information, contained in the structured parts list, of certain specified parts with the information for other parts, having comparable functions; deleting the piece of the parts information, contained in the structured parts list, of a certain specified part; and supplementing parts information of other new parts.

The process then proceeds to Step 7. In Step 7, the unit 3 instructs to store, into the storage unit, updated structured parts list information which is created/edited on the basis of the thus prepared structured parts list.

Subsequently in Step 8, the output unit 7 operates, based on the updated parts information list, to examine several predetermined items such as, for example, PWB packaging density, PWB manufacturing cost, parts floorplan, and simulation; and prepare decision information for compatibility prediction based on the results from the above examination, then instructs to display both the thus prepared decision information and the results from the above examination.

In addition, according to an input instruction by the input unit, decision prediction information is created and displayed to facilitate succeeding steps for the verification of circuit operation and characteristics. The decision prediction information herein is created as described earlier, based on the results from simulation steps which are carried out based on the variety of pieces of simulation model information which are filed on the basis of technical requirements foreseen for the circuit board already stored as the data base.

The process then proceeds to Step 9. In Step 9, an inquiry is made whether an instruction for re-edition is detected. If the response to the inquiry is affirmative, the process returns to Steep 6 to re-edit the structured parts list information, examines the above noted several items, and instructs to display the examination results. In contrast, if the response to the inquiry is negative, it is determined that the parts information list is completed, and the process ends.

There exemplified herein below are working screens on the display and working operations therewith during the creating/editing process steps of the structured parts list information.

FIG. 5 illustrates a retrieval screen on the display during the creating/editing process steps of the structured parts list information.

Referring to FIG. 5, when a keyword in the retrieval key input column 10 is selected during the process steps, corresponding to a certain presently desired item among various items such as unit or part class, PCB name, manufacturing location, PCB part number, part name (part number), and model status (model number), there displayed in retrieval result display column 11 is a table containing the portions of retrieval information from the resource DB 1 concerning to corresponding electronic circuit boards. In addition, more detailed information is displayed in retrieval result display column 12, concerning to a certain electronic circuit board selected among the boards in the table.

FIG. 6 illustrates a structured parts list creating/editing screen on the display during the structured parts list creating/editing process steps.

Referring to FIG. 6, when a desired electronic circuit board is selected during the process steps among the boards retrieved as descried just above, and when a resource input instruction is input, parts information concerning to the electronic circuit board corresponding to those presently selected is retrieved from the approved parts DB 2 based on the structured parts list information of the above selected electronic circuit board, and the resulting parts information is displayed in parts information list column 13 on the display.

FIG. 7 illustrates another structured parts list creating/editing screen on the display during the structured parts list creating/editing process steps.

Referring to FIG. 7, when substitution processing from some of the parts to others is intended in the parts information list column 13, the substitution step is carried out by first selecting the parts to be substituted in the column 13, then instructing to refer to those having comparable functions. The results containing the information on the retrieved parts having comparable functions are additionally displayed in the column 13 next to the lines previously displayed. Subsequently, by selecting parts among those in the thus updated list, the substitution is carried out from the parts to be substituted to those selected as above.

Also, when supplementing process of new parts is intended, supplementing steps are carried out, as shown in FIG. 7, by instructing the supplementing steps of parts information (indicated by the arrow 14 in FIG. 7) concerning to the retrieved parts based on, for example, the current price (part price). According to the instruction, the above parts information is subsequently supplemented into the parts information list column 13. In addition, several pieces of the information in the list 13 may also be deleted in a similar manner.

Following the preparation of the parts information list, operation verification steps are carried out for the portions of the circuits through processing the aforementioned simulation items, which follows.

First, the time to finish, which is to be input into a waveform simulator engine, is adjusted for generating the waveform. The time to finish is automatically set when the operation frequency of a driver changes. In addition, the time may also be adjusted manually.

In addition, a simulation grade is adjusted in a trade-off fashion between the simulation period of time. That is, more time is need with the increase in accuracy of the simulation.

Subsequently, a desired model is selected through inputting operations of simulation model parametrs among a model simulation net, or a variety of pieces of simulation model information formed beforehand based on technical requirements foreseen for the circuit board fabrication, and then input parameters for the presently selected model.

In addition, several initial values for the circuit, such as, for example, for a damping resistor may automatically be adjusted by the conventional advise function.

Simulation steps are then carried out, and the resulting waveform obtained from the simulation is then displayed through waveform display processing.

When an arbitrary point on the waveform is selected, a waveform information dialogue is displayed together with voltage and time for the selected node for the waveform. In addition, the difference in voltage from that expected for the certain time may also be displayed.

Further, through spectral display processing, spectral forms obtained by spectral analysis processing for respective transfer lines may also be displayed.

In addition, based on the thus obtained simulation results, circuit wiring rules are formed for the presently simulated circuit through support processing for creating layout rule, and layout rule information is then filed.

As described herein above, based on the structured parts list information concerning to previously manufactured electronic circuit boards, updated structured parts list information is thus created/edited after incorporating new capabilities, stored into the storage unit 6, examined concerning to several items, and determined following the aforementioned compatibility prediction, to subsequently be transferred to the succeeding manufacturing steps of the electronic circuit board fabrication.

This enables therefore for electrical restrictions on the circuits be critically examined based on the structured parts list information even prior to drawing circuit diagrams. As a result, it becomes feasible for the thus prepared compatibility prediction to be effectively utilized in the phase of circuit diagram drawing.

Next, there detailed herein below are examination items concerning to the aforementioned PWB packaging density, floorplanning and simulation.

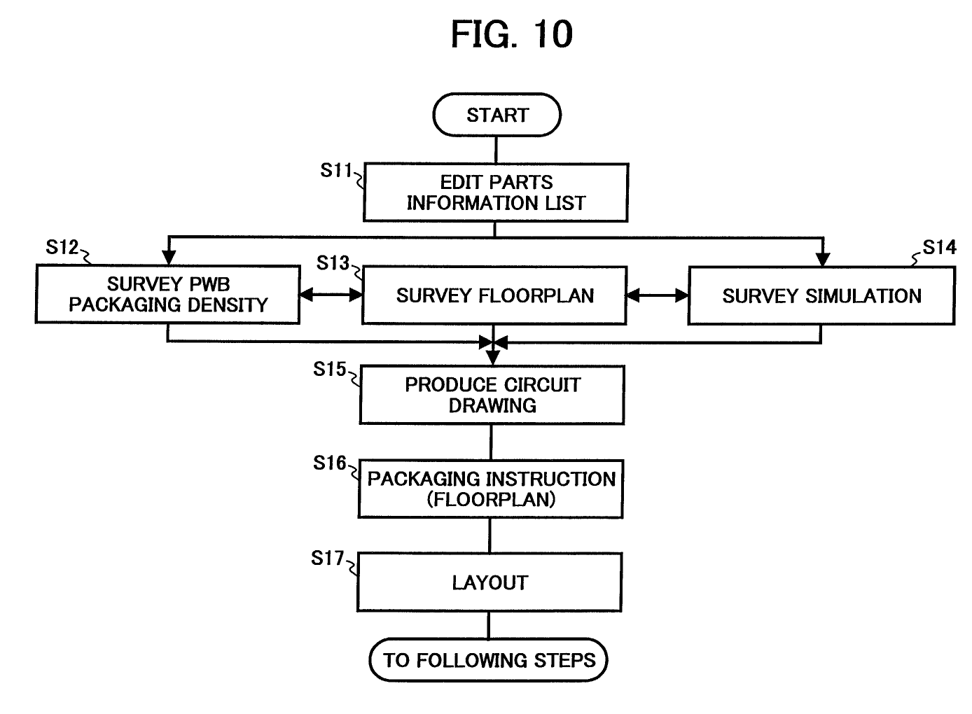

FIG. 10 includes a flow chart illustrating the processing steps from editing parts information list through the circuit layout.

Referring to FIG. 10, the parts information list is edited in Step 11, PWB packaging density, floorplan and simulation are surveyed in Steps 12, 13 and 14, respectively. Subsequently, in Step 15, circuit drawings are produced based on the results obtained from the above steps; packaging instructions are prepared in Step 16 based on the above circuit drawings and the results from the survey on floorplanning; a layout is formed in Step 17, then the process proceeds to the following steps.

The processing steps for the PWB packaging density survey are detailed herein below.

First, PWB packaging density examination tools, which are utilized in PWB packaging density survey, may be started from either the tool itself or the floorplanning tool for the floorplanning survey.

This examination tool serves primarily to survey relative readiness or difficulty of the PWB packaging density of interest, based on previously known results, when all components are mounted on the circuit board based on the parts information list. For example, when an updated graphical plot is made to be compared with another PWB packaging density plot which is produced from known results previous accumulated, a comment regarding the readiness of present packaging is obtained and displayed based in the difference from the upper limit of the previously accumulated plot.

Further, another PWB packaging density survey is also carried out with only key parts to be mounted, prior to deciding the layout with all components. From the results of the above survey, the number of other parts is estimated using assumed factors, and the packaging density is subsequently calculated.

Relative readiness is also surveyed for the case where all components are mounted on the desired layout area of the circuit board based on the structured parts list information for the circuit board which is tentatively laid out according to the floor planning.

Further, by surveying the change in the PWB packaging density with the PWB size, the minimum PWB size is obtained, which can be attained for the present floorplanning.

While PWB outer sizes are read from the floorplanning tool, the sizes are also input directly, to thereby facilitate the density survey for other cases, where either no circuit board is actually made, or smaller size of the board is intended to be surveyed.

In addition, approximate figures of PWB costs can be calculated by inputting PWB outer size, board thickness, materials, number of layers and vias.

Further, as the information useful in examining relative readiness of the PWB packaging density, PWB packaging densities, area, number of pins and costs are displayed to facilitate the ‘rolling design’ steps of the circuit boards, in which the term of rolling design is referred to designing utilizing circuit data and materials, which are created by modifying previous data for the present designing.

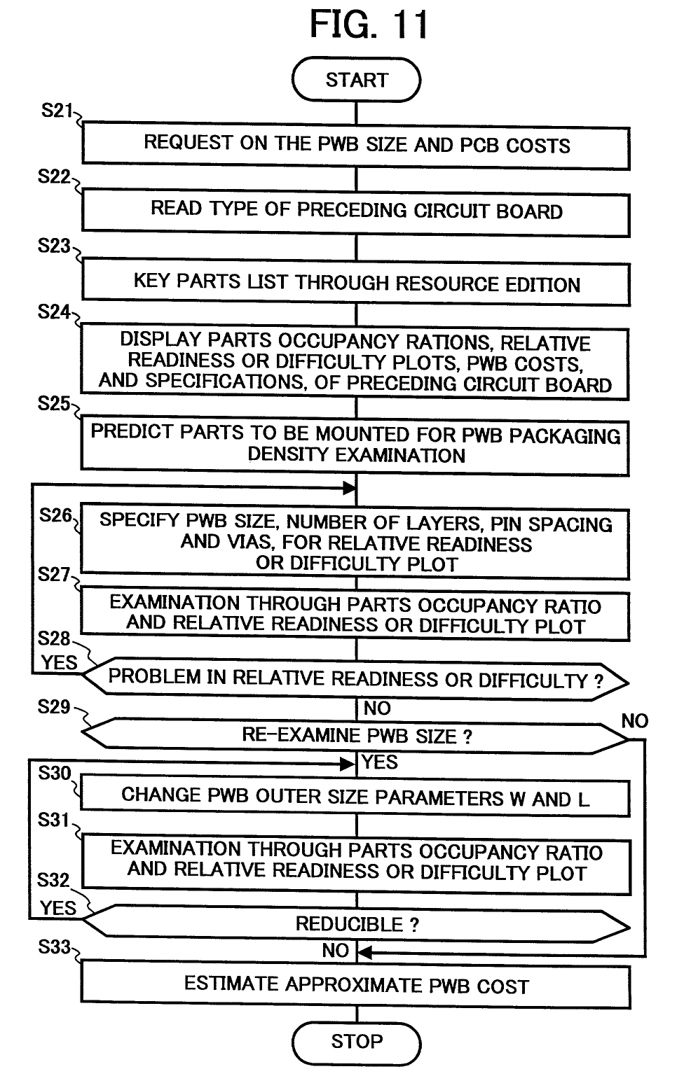

FIG. 11 includes a flow chart illustrating the processing steps of surveying PWB packaging densities by means of the effective PWB packaging density examination tool.

Referring to FIG. 11, on receiving the request from the planning section concerning to the PWB size and PCB costs in Step 21, the type of preceding circuit board is read in Step 22, and key parts list (a list containing only major components) is prepared in Step 23.

Subsequently, parts occupancy ratios, relative readiness or difficulty plots, PWB costs, and specifications are displayed in Step 24, parts to be mounted for the PWB packaging density examination are selected in Step 25; PWB sizes, number of layers, pin spacing, and vias are specified in Step 26; and the PWB packaging density examination is carried out in Step 27 with the thus prepared parts occupancy ratios and relative readiness or difficulty.

An inquiry is then made in Step 28 whether any problem is present in the relative readiness or difficulty. If the response to the inquiry is affirmative, the process returns to Step 26 and the examination process is repeated. In contrast, if the response is negative, the process proceeds to Step 29, where another inquiry is made in Step 29 whether re-examination of PWB size is necessary. If the response to the inquiry is negative, the process proceeds to Step 33, while the process proceeds to Step 30, if the response is affirmative.

In Step 30, several PWB outer size parameters such as W and L are changed, and another examination is subsequently carried out in Step 31 with the thus specified parts occupancy ratio and relative readiness or difficulty.

In addition, there inquired in Step 32 is whether the size is reducible. If the response is affirmative, the process returns to Step 30, and examination steps are repeated. If the response is negative, an approximate PWB cost is calculated, and then the process ends.

Next, there described herein below are screens on the display and handling methods thereof during process steps of PWB packaging density survey.

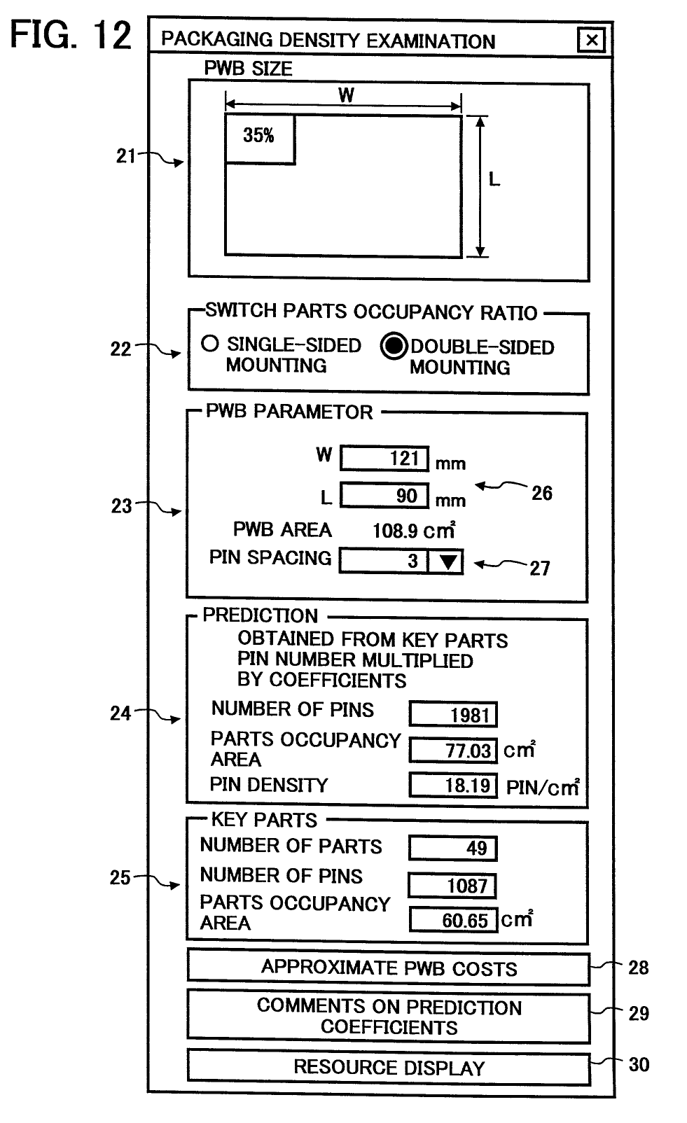

FIG. 12 includes a screen on the display illustrating a main screen during survey and examination steps carried out by means of the effective PWB packaging density examination tool.

Referring to FIG. 12, the screen on the display contains a plurality picture columns respectively provided for PWB size 21, parts occupancy display and switch 22, PWB parameter input 23, parts prediction display (display of predicted part number and part information) 24, key part input 25, and PWB outer size input 26, pin spacing 27.

Also provided are approximate PWB cost reference display button 28, parts prediction coefficients reference instruction button 29, and resource display instruction button 30, which are respectively provided as the interface for picture display of approximate PWB cost, reference instruction picture display of parts prediction coefficients, and input instruction display of resource part number.

The PWB size display column 21 serves to display images of the PWB parts occupancy ratios for the circuit board of interest, and the parts occupancy display and switch column 22 serves to select single- or double-sided mounting.

The PWB parameter input column 23 displays an PWB area, which further contains the PWB outer size input column 26 and pin spacing and pin number selection column 27.

The prediction display column 24 displays the number of pins, parts occupancy area, and density of pins, which are calculated based on the prediction coefficients.

Into the PWB outer size input column 26 in the PWB parameter input column 23, a PWB outer size is input with W and L; and in the pin number and pin spacing selection column 27, a number of pins is input. A PWB packaging density graph is subsequently displayed in the form which is presently modified according to the pin number and pin spacing presently input.

Through pull-down operations of respective screens on the display, the PWB approximate cost reference display button 28 is configured to instruct to display the screen on the display of PWB approximate cost, prediction coefficients reference instruction button 29 is configured to display the image of parts prediction coefficients, and the resource display instruction button 30 is configured to display resource part numbers, respectively.

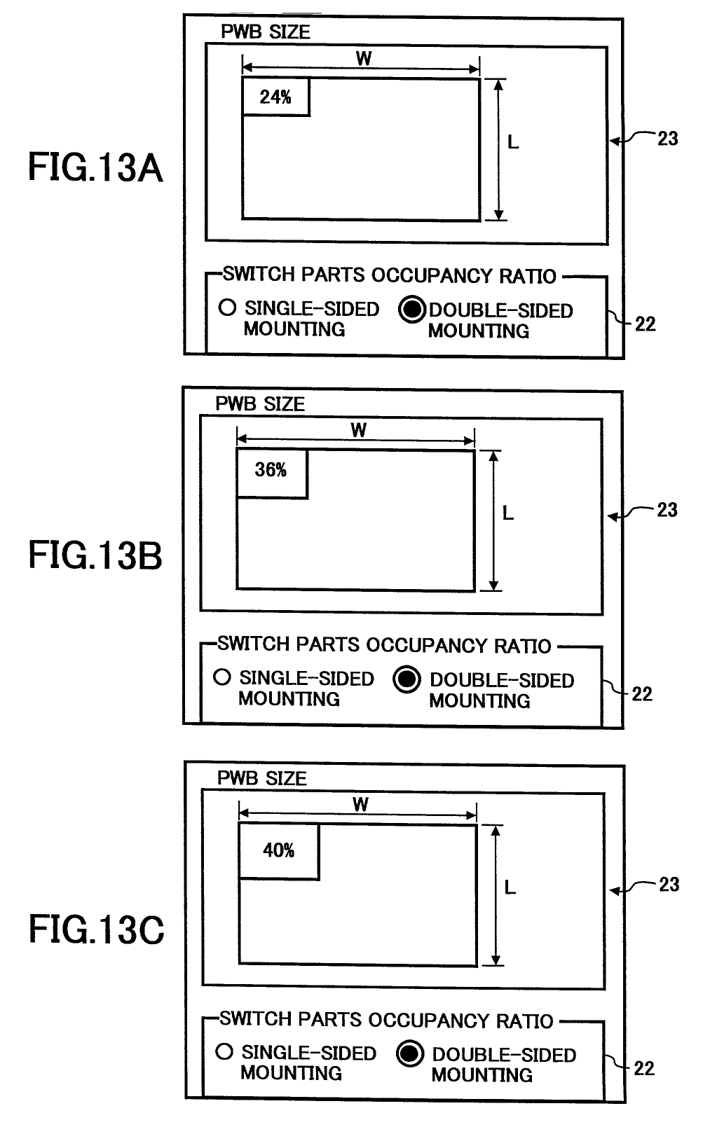

FIGS. 13A, 13B and 13C are prepared to illustrate screens of the occupancy area ratios by the PWB, which are displayed in the PWB size display column 21. There displayed herein are PWB outer sizes with images and PWB parts occupancy area ratios which are defined by the ratio in percent of the area occupied by predicted mounted parts on the PWB to that of the PWB. Several cases of the PWB parts occupancy area ratio are exemplified, as shown for the ratio of 24% in FIG. 13A, 35% in FIG. 13B, and 40% in FIG. 13C, respectively.

When these images may be respectively displayed in different colors to facilitate the visual distinction. For example, there may be displayed for the ratio of 30% or smaller in blue, from 25% to 35% in pink, and 36% or larger in red, respectively.

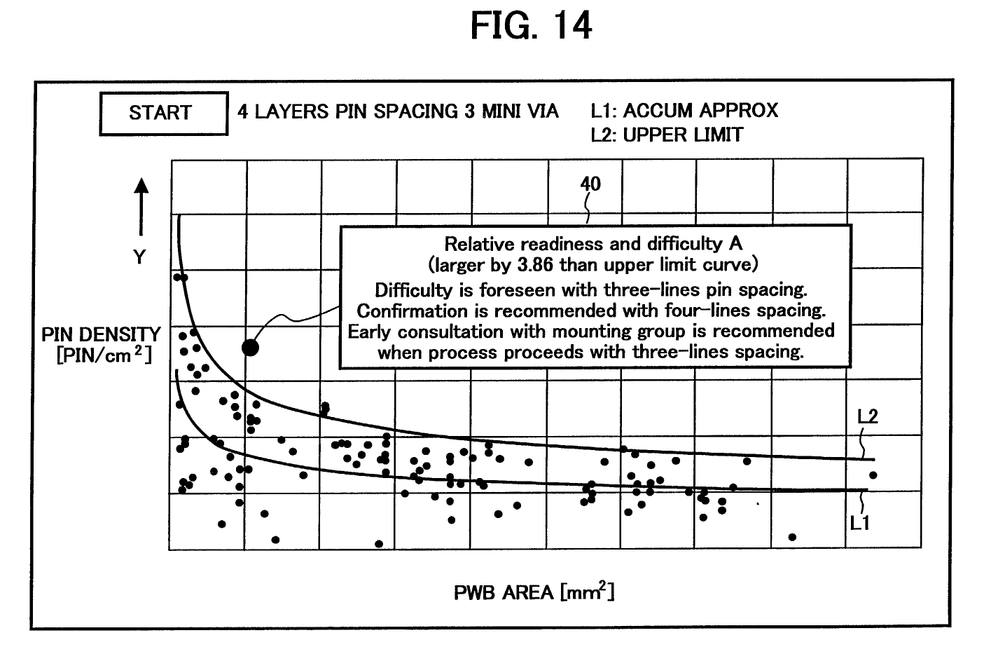

FIGS. 14 through 16 include graphs illustrating PWB packaging density plots according to the present embodiment.

When present values for the pin number and pin spacing are input in the pin spacing selection column 27 in the main screen display, PWB packaging density plots are subsequently modified and then displayed according to the thus input values, which follows.

First, both average and upper limit curves are displayed, which are produced from known results previously accumulated, and an updated graphical plot is additionally shown indicative of the PWB packaging density for the PWB of interest at present (which is shown incidentally with a dot having a diameter emphasized for the purpose of distinction) together with a comment concerning to the plot. Further, the content of the comment and the background color are changed depending on the packaging density presently obtained.

For example, when the density value of a plot is larger by at least 2 pins/cm² than that of the upper limit curve as shown in FIG. 14, a comment is displayed against red background in the comment area 40, which contains a message suggesting a further survey with altered parameters.

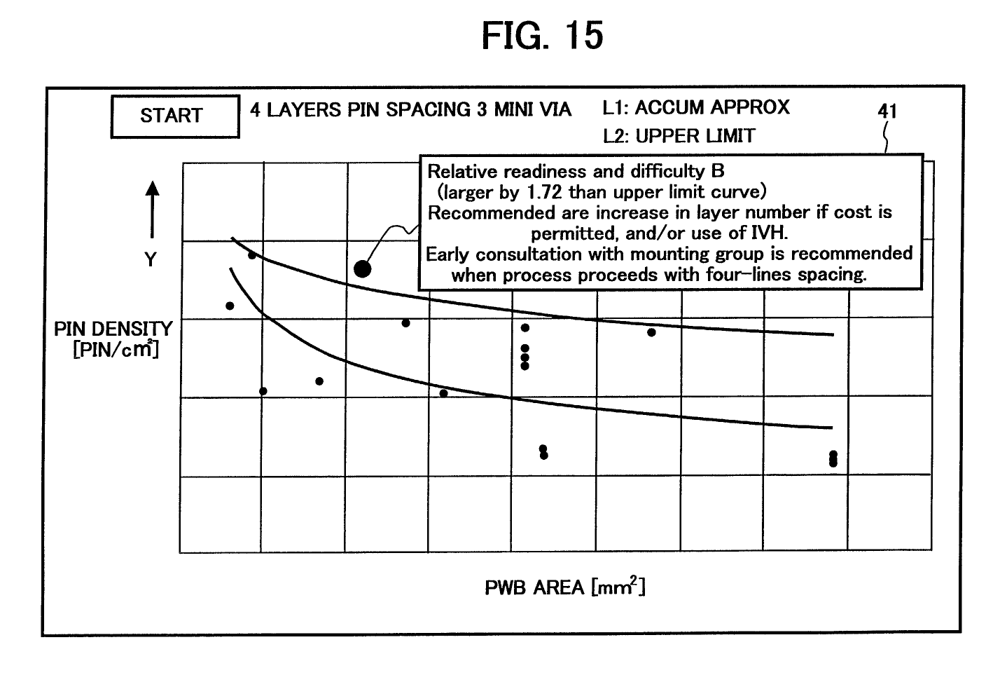

In contrast, when the density value of another plot is smaller by at most 2 pins/cm² than that of the upper limit curve as shown in FIG. 15, another comment is displayed against yellow background in the area 41, indicating consultation with the packaging group is recommended in case where the process is intended to proceed with the present parameters.

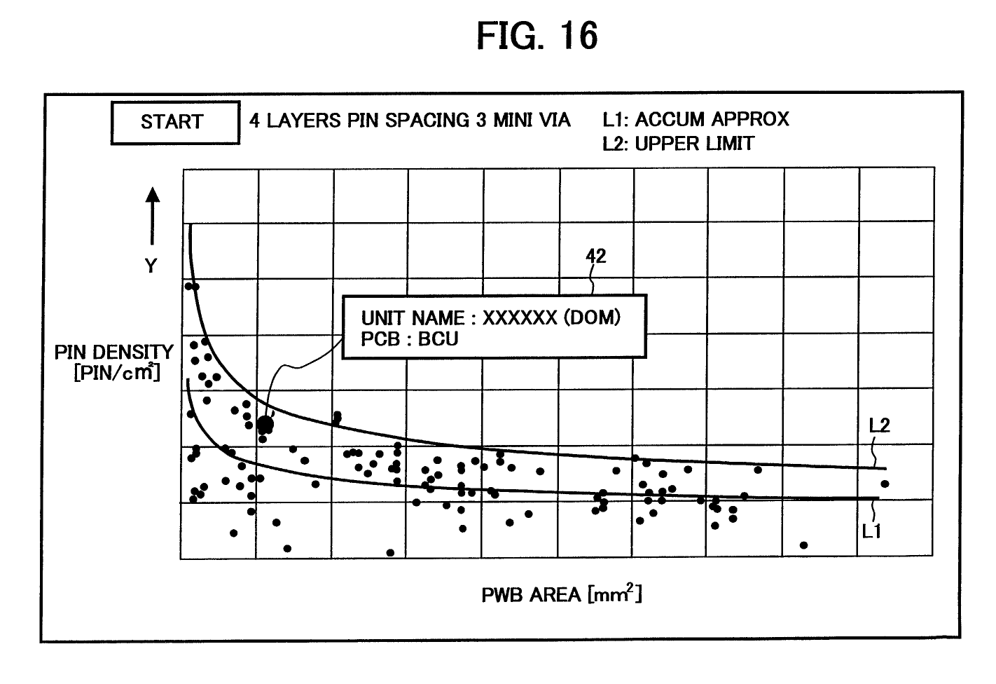

When a resource display process is carried out through a pull-down operation of the resource display instruction button 30, another comment 42 is displayed containing the names of the unit and PCB, as shown in FIG. 16.

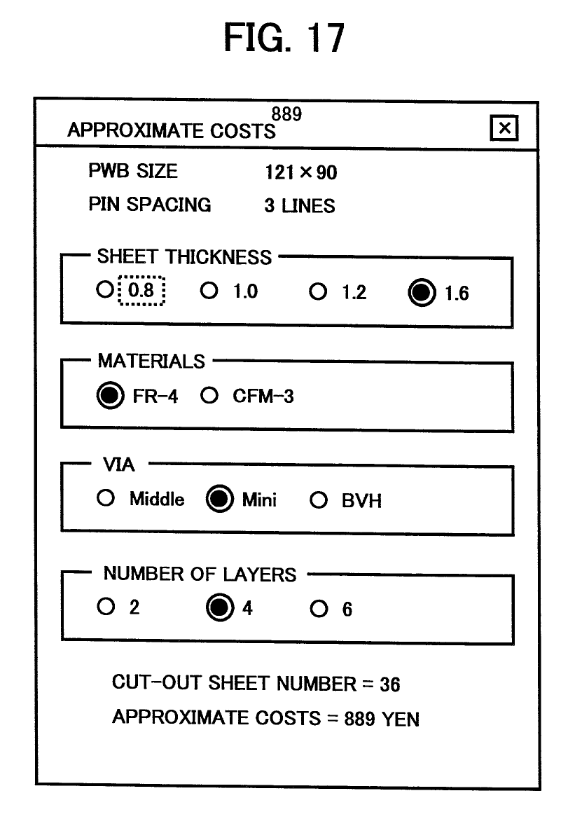

FIG. 17 is prepared to illustrate a screen for displaying approximate PWB costs.

When the approximate PWB cost reference display button 28 is pulled down, a screen is displayed of approximate PWB costs, as shown in FIG. 17.

On the screen concerning to approximate PWB costs, there displayed is a ‘cut-out sheet number’, i.e., the number of PWBs which can be cut or quarried out of one sheet according to the specified PWB size. Also displayed is an approximate cost which is obtained using several parameters of the board such as thickness, material, via and layer number, together with the above noted cut-out sheet number. The approximate cost is calculated and then displayed, for example, assuming a mass-production phase with the sheet consumption of 10-50 cm²/month.

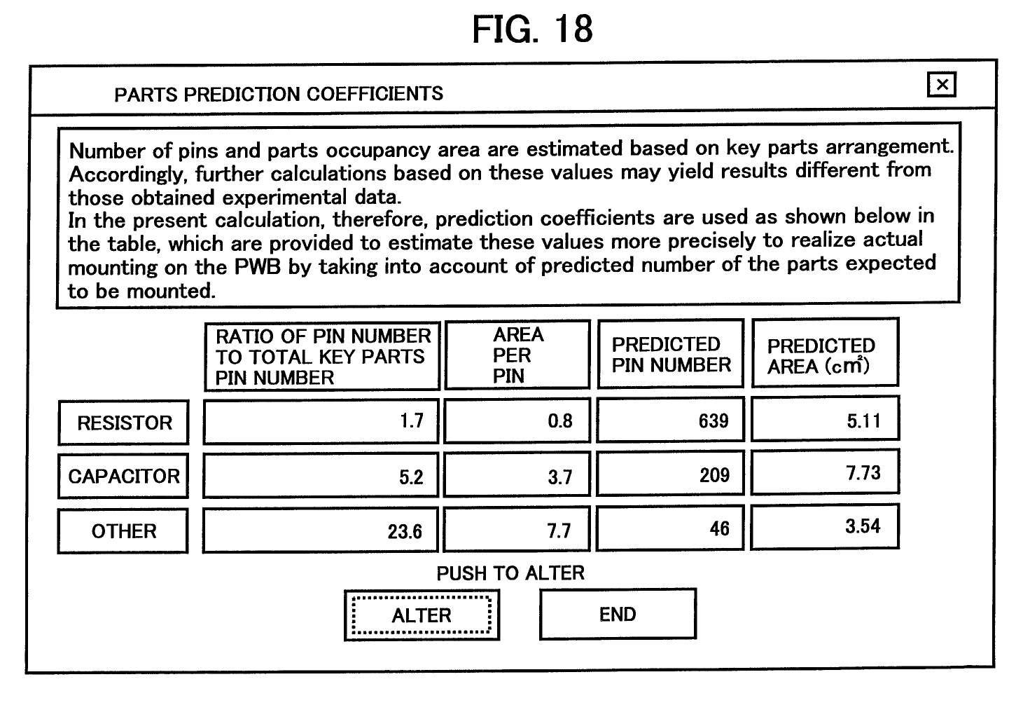

FIG. 18 is prepared to illustrate a screen for displaying parts prediction coefficients.

When parts prediction coefficients reference instruction button 29 is pulled down, a screen is displayed of parts prediction coefficients, as shown in FIG. 18.

Since PWB density estimation is carried out based on the parts information list (of only key parts), a number of other parts such as chip parts and discrete parts have to be incorporated before completing the PCB fabrication. In order to predict to a certain extent the number of these additional parts, therefore, the following parts prediction coefficients are used and then displayed in the screen. They are related to two coefficients; one is the ratio of the pin number of parts to that of all of the key parts, and the other is the area for each pin of the parts.

In addition, these coefficients are used being divided broadly for three kinds of parts such as resistors, capacitors, and others. The coefficient for the respective kinds of the parts indicates the ratio of the pin number of the parts to that of all of the key parts. Further, the output number is indicated not by the number of the parts but that of pins, for example, since resistors may also be included in arrays in addition to chips.

Regarding the pin area, the value of 0.8 cm² is adopted for resistor, assuming primarily chip resistor; 3.7 cm² for capacitor, assuming both chip and radial types; and 7.7 cm² for other parts, assuming the average of the values for SMD and DIP types.

Further, although the estimation of the parts predicted to be mounted is made and then displayed based on the coefficients, as described above, other coefficients may be necessitated depending on other parts construction such as, for example, different key parts and more bus lines. In the present embodiment, therefore, measures are provided for a user to appropriately change the values of these coefficients.

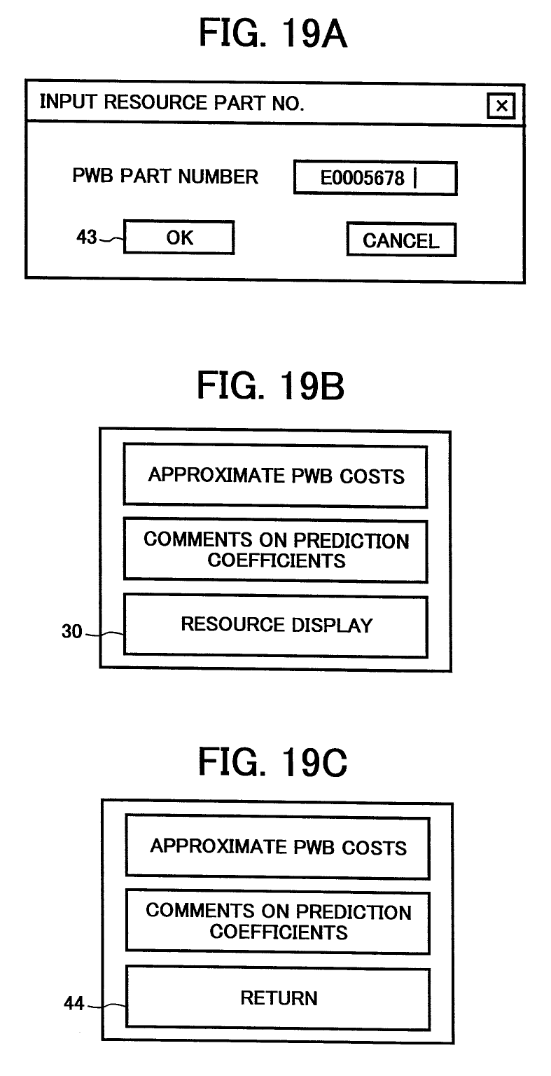

FIGS. 19A, 19B and 19C are prepared to illustrate screens for displaying the steps of resource part number input.

When resource display instruction button 30 is pulled down, a screen is displayed of resource part number input as a resource display, as shown in FIG. 19A. By inputting a PWB part number and then pulling the OK button 43 down on the screen, several pieces of information such as size, total pin number, parts occupancy area, pin density, layer number and vias are input, then a PWB packaging density curve is displayed together with some of the input information as shown in FIG. 16.

In addition, regarding the main processing screen, the resource display instruction button 30 appears before displaying a resource screen shown in FIG. 19B; while resource display instruction button 30 appears as shown in FIG. 19C during the period of displaying the resource screen, this in turn operates to return to the screen before the displaying the resource screen of FIG. 19B by pulling down a return button 44.

The processing steps for floorplanning survey are detailed herein below.

Several processing steps may be carried out in the floorplanning survey, which follows.

(1) Read or input either parts information list or circuit data to make tentative parts arrangement using a real footprint, thereby examining whether mounting can be achieved within the PWB size,

(2) optimize parts arrangement considering height limits, connector positions, and routing of signal patterns,

(3) carry out wire connections for the parts which are tentatively arranged for the simulation,

(4) produce specification requirements such as blocked areas, mounting locations, height limits, pattern routing and equidistant wiring,

(5) transfer, to the layout group, the layout requirements (specification) which are prepared based on the results from analysis by logic designers,

(6) during the step of, for example, the aforementioned rolling design, confirm previous specifications and examine whether they are reusable.

Also in the floorplanning survey, several functions may be implemented, which are broadly described as follows.

(1) Produce PWB outer view drawings, specify layer number and materials, transfer them to the mounting density examination tool,

(2) implement reusing steps of requirements in an actual layout which is produced by inputting the above noted blocked areas, mounting locations, height limits, pattern routing and equidistant wiring,

(3) transfer, to the simulation group, the netlist information to be used in the simulation, receive the results from the simulation, and then store them as a specification,

(4) arrange parts by means of either drag operations or input coordinates, and

(5) affix several comments concerning to either quantitative restrictions (such as coordinate location, length or width) or other restrictive items which cannot be expressed quantitatively, and then transfer them to a layout CAD.

In addition, several functions may further be carried out as follows.

(1) Produce PWB outer view drawings and layer construction,

(2) form blocked areas (for parts mounting and pattern forming),

(3) specify height limited areas,

(4) specify the position and then form fixing holes,

(5) prepare parts information list (parts list) and display parts yet to be mounted based on circuit diagram,

(6) supplement the parts which are not found in the parts information list (parts table) or circuit drawing,

(7) change the parts which are already included in the parts information list (parts table) or circuit drawing,

(8) arbitrary arrange parts either on parts side of, or soldered side of the circuit board, or arrange by inputting coordinates,

(9) lock part locations (complete lock or partial lock),

(10) specify the distance between parts,

(11) prepare comments on parts,

(12) restrictions when the parts are specified by click operations, and display comments thereof,

(13) form sources and grounds,

(14) form signals lines and buses,

(15) specify the length and width of signals lines and buses,

(16) prepare comments on signals lines and buses,

(17) restrictions when signals lines are specified by click operations, and display comments thereof,

(18) generate net names automatically and original net names,

(19) write other comments or remarks,

(20) display the startup of parts property PDF file, and

(21) start up simulation steps.

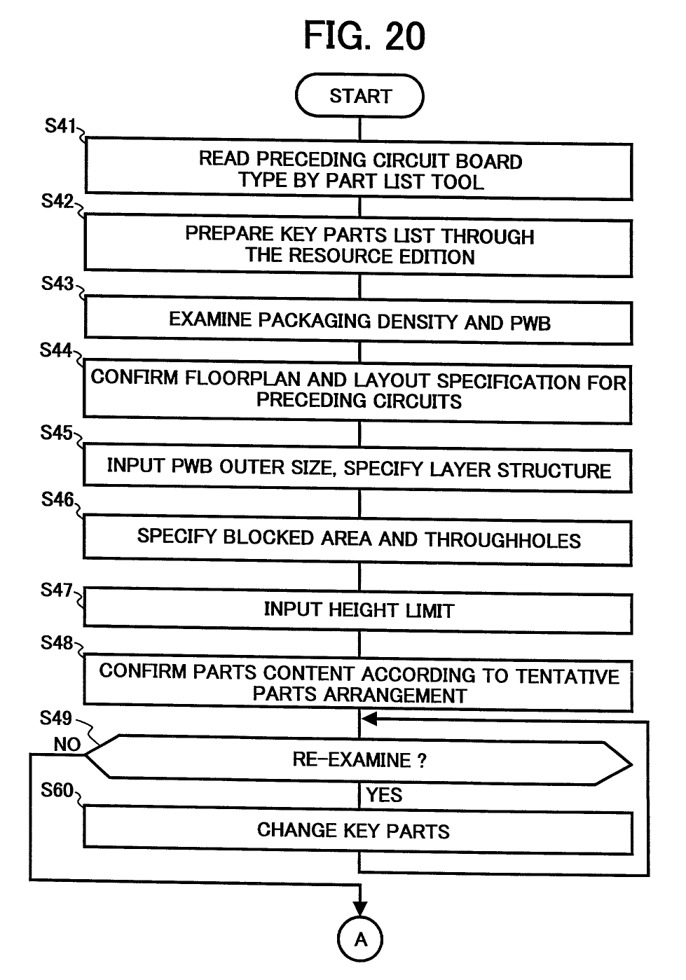

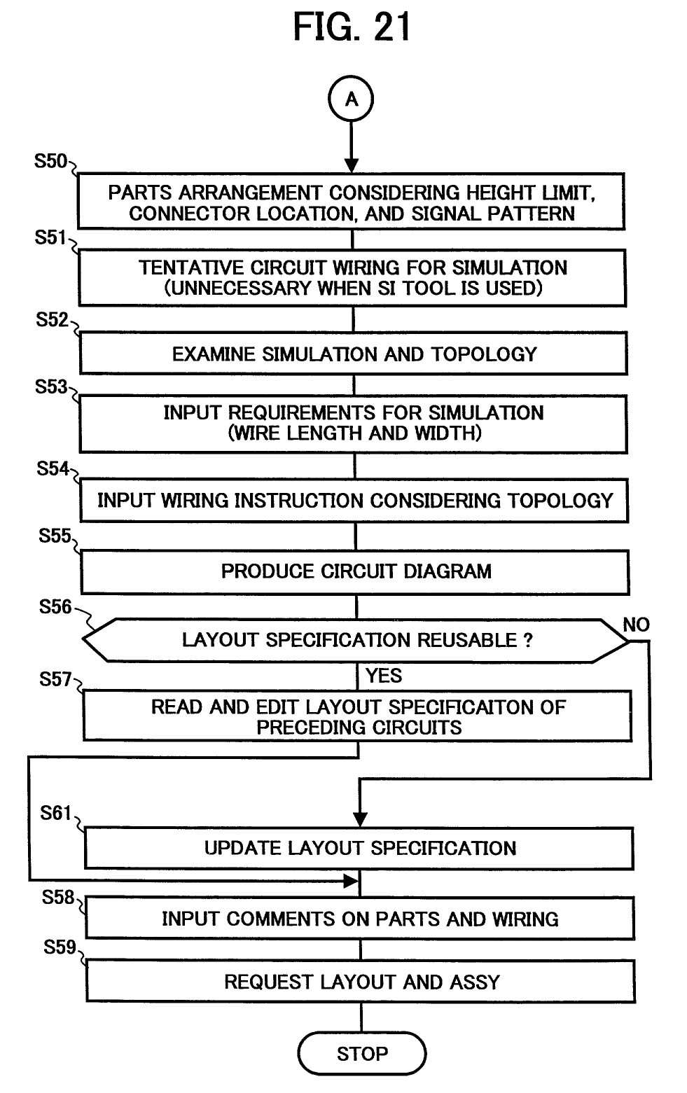

FIGS. 20 and 21 include a flow chart illustrating processing steps for preparing a parts information list and examining a floorplan by the floorplanning tool.

Referring to FIG. 20, the type of preceding circuit board is read out from the parts list tool in Step 41, and prepare a key parts list (parts information list) in Step 42 through editing the resources.

Subsequently, when the packaging density and PWB are examined in Step 43, the floorplan and layout specification for the preceding circuits is confirmed in Step 44, the outer size of PWB is input and layer structure is specified in Step 45, blocked area and through holes are input in Step 46, and height limit is specified in Step 47; a parts content is then confirmed according the present tentative parts arrangement in Step 48 and inquire whether another examination is necessary in Step 49.

If the response to the inquiry is affirmative, the process proceeds to Step 60 to change key parts, then returns to Step 48 to repeat the processing steps. In contrast, if the response is negative, parts arrangement is carried out in Step 50, as shown in FIG. 21, considering the height limit, connector location, and signal pattern. Then, tentative wiring for simulation is created in Step 51, and simulation and topology are examined in Step 52.

In Step 53, several requirements for the simulation, such as wire length and width of circuit wires, are input, a wiring specification instruction considering the topology is input in Step 54, a circuit diagram is produced in Step 55, and an inquiry is made whether the layout specification can be reused in Step 56.

If it is decided in Step 56 that the layout specification can be reused, the layout specification for the preceding circuits is read and then edited in Step 57, the process proceeds to Step 58. If it is decided that the layout specification cannot be reused, a new layout specification is created in Step 61, then the process proceeds to Step 58. After comments on parts and wiring are input in Step 58, and a layout and Assy (i.e., assembly) are requested in Step 59, the process proceeds to the following process steps.

There described next are interfaces between the floorplanning tool and several other tools.

(1) The Interface between the Parts Information List.

This interface serves to read the part described in the parts information list, and a footprint corresponding to the part is then displayed on the pre-arranged box.

First, when any part supplementation, deletion or alteration is made to the part included in the parts information list, this is reported to either pre-arranged box or floorplan in real time manner.

In case of supplementation, the report is made to pre-arrangement box. In case of deletion, on the other hand, the deletion step is made from the pre-arrangement box. Further, when the part is already arranged in the floor plan, a balloon display is shown in the vicinity of the part of interest, indicating that the deletion is made from the parts information list, and then confirm the deletion from the floor plan. In addition, in case of deletion NG, a reinstallment is made of the part to the parts information list. Still further, in case of alteration with the part being still in the pre-arrangement box, the part to be altered is deleted, and then the footprint of an altered part is added.

In contrast, when part supplementation, deletion or alteration is found in the floorplan, this is reflected in real time manner.

(2) The Interface between Circuit Diagram CAD.

When any part supplementation, deletion or alteration is found, this is reported to either pre-arranged box or floorplan in real time manner.

In case of supplementation, the report is made to pre-arrangement box. In case of deletion, on the other hand, the deletion step is made from the pre-arrangement box. Further, when the part is already arranged in the floor plan, a balloon display is shown in the vicinity of the part of interest, indicating that the deletion is made from the parts information list, and then confirm the deletion from the floor plan. In addition, in case of deletion NG, a reinstallment is made of the part to the parts information list. Still further, in case of alteration with the part being still in the pre-arrangement box, the part to be altered is deleted, and then the footprint of an altered part is added.

When the circuit diagram is yet to be created, the net information concerning to the wired circuit which are connected by the floorplan is confirmed by the circuit diagram side, wire connecting steps by the circuit diagram side are then carried out with guiding. When the restoration of a wire connection is intended during the circuit diagram preparation steps, a net information matching is made between non-matched circuit portions, thereby restoring the irrelevant net information. It is necessary during the steps for the net non-match can be suitably confirmed.

When any part supplementation, deletion or alteration is found in the floorplan, this is reported so as to change the alteration box on the circuit diagram in real time manner. When any part supplementation, deletion or alteration is made on the circuit diagram side, no automatic updating step is carried out to the side of the floorplan. In addition, the net information on the circuit diagram can be referred from the floorplan side, and the portions non-matched with the circuit diagram can also be confirmed based on the floorplan.

(3) The Interface between the Simulator.

This interface serves to send net information to the simulation side. When dumping, pull-up or pull-down resistors are supplemented as a result of the simulation, several pieces of parts information such as circuit wire length, width and location of the circuit wire are transferred as numerical information, and these changes are automatically reflected to the parts location and wiring corrections on the floorplan side. In addition, there also transferred are not only net information but also connection route (wire connection types such as the star connection, single stroke and others similar methods).

(4) The Interface between the Layout CAD.

This interface has several capabilities primarily of transferring, such as the PWB outer shape into the form to be usable in layout CAD operations; topology information, and a DRC (design rule checker) being operable therefor; specified data on circuit wire length and width to net information, and the DRC being operable therefor; specified data on the inter-parts distance to net information, and the DRC being operable therefor; the two kinds of specified data, in which ones are specified by the location fixed, while the others are specified with designated, allowed range of location, and the DRC being operable therefor; and the information on blocked areas and height data.

Incidentally, the structured parts list creating/editing system is detailed so far primarily on its functional unit specifically related to the embodiment disclosed herein. It may be added, however, that other functional units may additionally be provided. For example, the units may be ones used in circuit designing such as designing, drawing, verifying and other similar functional units.

With the units having above described capabilities, and based on the thus prepared updated structured parts list information of electronic circuit boards, various process steps of circuit design becomes feasible including designing, drawing, and verifying, by means of a single system.

In addition, the structured parts list creating/editing system may further be able to carry out parts selection process steps more efficiently.

Namely, in the structured parts list creating/editing system, the resource DB 1 and approved parts DB 2 are interconnected by way of communication network such as, for example, the public telephone network or optical communication network, and further incorporating a number of other structured parts list creating/editing systems to be mutually linked by way of the communication network so that for the resource DB 1 and approved parts DB 2 be able to be referred each other and from the other structured parts list creating/editing systems as well. Since the construction of the above noted structured parts list creating/editing systems with the resource DB 1 and approved parts DB 2 through the network enables for these data bases be utilized by a number of users, as common data bases, this may considerably facilitate efficient process steps of selecting most suitable parts for the electronic circuit boards presently concerned.

Although there is detailed so far in the present embodiment, on a rather specific system construction of the creating/editing system in exclusive use for the above noted structured parts list creating/editing process steps, the above noted structured part list process steps may also be carried out with an information processing apparatus such as, for example, a conventional personal computer, in which programs for the above noted process steps is installed in a storage medium such as, for example, a floppy disk and optical disk, then executed by a control unit in the information processing apparatus (functional units embodied in the apparatus such as CPU, ROM, RAM and other similar devices).

Namely, the above noted storage media such as floppy disk and optical disk serve as storage means to store various programs of processing steps to subsequently be utilized for executing the programs, having the following capabilities (1) through (6) comparable to those with storage unit in the aforementioned structured parts list creating/editing system.

These comparable capabilities or functions are (1) structured parts list information storage functions capable of storing a plurality of pieces of information of structured parts list constituted of various kinds of electronic components, (2) parts information storage functions capable of storing a plurality of pieces of parts information concerning to identification, function, manufacturer, size, shape, future prospect, price and approval data regarding, for example, whether the part of interest is approved for present use, (3) resource parts list creating/editing functions capable of preparing a parts information list by first retrieving the parts information of respective parts in the structured parts list information, which is stored from parts information, then preparing a parts information list for respective parts included in the structured parts list information, (4) structured parts list information creating/editing functions capable of creating/editing an updated structured parts list information based on the parts information list prepared as described above, (5) compatibility prediction decision information outputting functions capable of estimating packaging densities for the arrangement of all components mounted on or within desired layout area of the circuit board based on the updated created/edited parts information list in the structured parts list information, and preparing decision information for compatibility prediction based on the results from the above estimation, then instructing to display the thus prepared decision information, and (6) compatibility prediction decision information outputting functions capable of performing the arrangement of all the components within desired layout area of the circuit board based on the updated created/edited parts information list in the structured parts list information together with predetermined several restrictions, and preparing decision information for compatibility prediction based on the results from the above arrangement, then instructing to display the thus prepared decision information.

Subsequently, a control unit in the above noted information processing apparatus such as a conventional personal computer executes, based on the parts information list prepared above, various processing steps such as storing a plurality of pieces of information on structured parts list, storing a plurality of pieces of parts information concerning to identification, function, manufacturer, size, shape, future prospect, price and approval data regarding whether the part of interest is approved for present use; preparing a parts information list by first retrieving the parts information of respective parts in the structured parts list information, then preparing a parts information list for respective parts included in the structured parts list information; creating/editing an updated structured parts list information based on the parts information list prepared as above; and examining several predetermined items based on the updated structured parts list information and preparing, then outputting decision information for compatibility prediction prepared based on the results from the above examination.

In addition, the above control unit also executes further processing steps such as preparing a parts information list by first retrieving the parts information of respective parts in the structured parts list information, which is stored from parts information, then preparing a parts information list for respective parts included in the structured parts list information; creating/editing an updated structured parts list information based on the parts information list prepared as described above; estimating packaging densities for the arrangement of all components mounted on or within desired layout area of the circuit board based on the updated created/edited parts information list in the structured parts list information; and preparing decision information for compatibility prediction based on the results from the above estimation, then instructing to display the thus prepared decision information.

Further, the above control unit also executes further processing steps such as preparing a parts information list by first retrieving the parts information of respective parts in the structured parts list information, which is stored from parts information, then preparing a parts information list for respective parts included in the structured parts list information; creating/editing an updated structured parts list information based on the parts information list prepared as described above; performing the arrangement of all the components within desired layout area of the circuit board based on the updated created/edited parts information list in the structured parts list information together with predetermined several restrictions, and preparing decision information for compatibility prediction based on the results from the above arrangement, then instructing to display the thus prepared decision information.

According to the embodiment disclosed herein, it becomes not mandatory, for respective parts to be referred one by one to either a catalogue or data sheet provided by the manufacturer during creating/editing steps of new structured parts list information concerning to the electronic circuit boards. Therefore, workloads of reference and/or retrieval works may considerably be reduced.

In addition, since the parts information to be presently referred is generally the latest for the parts and aforementioned status information (or approval information) especially useful in decision making steps can also be referred, structured parts list information concerning to new electronic circuit boards can be prepared efficiently in relatively short period of time.

Through the above updated structured parts list information, undesirable effects can be avoided, which are caused by possible undue situations such as, for example, changes in specification, shape and/or price, or discontinuation of manufacturing of the parts, which are unnoticed up to the point of, or after creating the parts information. In such cases, recreating structured parts list information, parts substitution to other ones, or even the change in the initial design may otherwise be necessitated. Namely, by providing the updated structured parts list information, therefore, unfavorable situations against efficient electronic circuit board manufacturing and concurrent undue waste of manufacturing costs can therefore be alleviated.

Further, once an updated structured parts list information is created, survey results on predetermined items such as PWB packaging density, PWB manufacturing cost, parts floorplan, and simulation (circuit operation verification), and also compatibility prediction based on the results from the above examination, included therein may be referred, inconvenience, if any, and/or feasibility for the electronic circuit board can be estimated without delay. This facilitates, therefore, to reduce considerably the workload for designing circuit boards having desirable characteristics within certain predetermined costs.

Still further, since newly designed circuits may be verified for respective portions thereof with relative ease, operations and characteristics of desired circuits can be examined quite easily without redesigning the circuits from the start.

Since the updated structured parts list information can quickly be transferred to, or shared by, various processes, succeeding steps from development through manufacturing processes can proceed smoothly, thereby enabling new products be input timely into the market.

Incidentally, although the creating/editing process steps according to the present embodiment are detailed on structured parts list information based on parts information concerning to electronic circuit boards, these process steps may also be adopted to other apparatus such as, for example, machine tools and control apparatus in a similar manner.

Namely, this may be carried out by storing structured parts list information of various machine tools and other similar apparatus into a resource DB, storing parts information of various machine tools and other similar apparatus into an approved parts DB, retrieving the parts information of corresponding parts by the resource parts list creating/editing unit from the resource DB based on the structured parts list information retrieved from the resource DB, then preparing a parts information list; by the compatibility prediction information output unit 7, carrying out the survey on predetermined items such as PWB packaging density, PWB manufacturing cost, parts floorplan, and simulation (circuit operation verification), to subsequently output compatibility prediction prepared based on the survey, together with survey results.

It is apparent from the above description that the structured parts list creating/editing system, method for creating/editing a structured parts list, and computer accessible storage medium configured to store structured parts list creating/editing programs for a computer to execute, disclosed herein, are advantageous over previous known systems and methods.

Namely, compatibility predictions for the part of present interest concerning to predetermined conditions can be tested with relative ease during process steps of creating/editing structured parts list information of component such as, for example, electronic circuit boards, based on the latest parts information.

As a result, structured parts list information concerning to new electronic circuit boards can be prepared efficiently in relatively short period of time, to thereby facilitate considerably for reducing workloads of reference and retrieval works and undue waste of manufacturing costs, among others.

Additional modifications and variations of the present invention are possible in light of the above teachings. It is therefore to be understood that within the scope of the appended claims, the invention may be practiced otherwise than as specifically described herein by way of non-limiting examples.

This document claims priority and contains subject matter related to Japanese Patent Applications Nos. 2000-30155, 2000-94614, 2000-141949, and 2000-204594, filed with the Japanese Patent Office on Feb. 8, 2000, Mar. 30, 2000, May 15, 2000 and Jul. 6, 2000, respectively, the entire contents of which are hereby incorporated by reference.

What is claimed as new and desired to be secured by Letters Patent of the United States is:

1. A system for creating and editing structured parts list information, comprising:
a structured parts list information storage configured to store structured parts list information on components including a plurality of kinds of parts;
a parts information storage configured to store parts information on a plurality of parts;
a parts information list creating and editing device configured to retrieve parts information on respective parts, stored in said structured parts list information storage, and to create a parts information list; and
a structured parts information list creating and editing device configured to create updated structured parts list information based on said parts information list created by said parts information list creating and editing device.

2. The system according to claim 1,
wherein:
said parts information on respective parts include information on, at least, an identification, a function, a manufacture, a feature of at least one of size and shape, a future prospect, a price, and approval data related to approval and non-approval for use.

3. The system according to claim 1, further comprising:
a compatibility prediction information output device configured to survey on predetermined items based on said parts information list created by said parts information list creating and editing device, and to create and then output decision information for compatibility prediction based on results from said survey.

4. The system according to claim 3,
wherein:
said predetermined items on respective parts include at least packaging density, arrangement, and operation verification.

5. The system according to claim 1, further comprising:
a compatibility prediction information output device configured to store predetermined information on simulation models, based on technical requirements, to carry out simulation steps using parameters corresponding to models selected from said simulation models, and to create prediction information based on simulation results.

6. The system according to claim 1, further comprising:
a compatibility prediction information output device configured to estimate packaging densities for an arrangement with all components mounted within a desired layout area based on said updated parts information list in said structured parts information list, and to create and then output decision information for compatibility prediction based on packaging density results.

7. The system according to claim 1, further comprising:
a compatibility prediction information output device configured to estimate packaging densities for an arrangement with all components mounted within a desired layout area based on said updated parts information list in said structured parts information list together with predetermined restrictions, and to create and then output decision information for compatibility prediction based on packaging density results.

8. The system according to claim 7,
wherein:
said predetermined restrictions include at least restrictions concerning layout blocked area, part height, connector position, part location, pattern routing, and equi-trace-length requirements.

9. A method for creating and editing structured parts list information, comprising the steps of:
storing structured parts list information on components including a plurality of kinds of parts;
storing parts information on components including a plurality of parts;
retrieving parts information on respective parts stored in said structured parts list information;
creating a parts information list of said respective parts; and
creating and editing updated structured parts list information based on said parts information list.

10. The method according to claim 9,
wherein:
said parts information on respective parts include information on, at least, an identification, a function, a manufacture, a feature of at least one of size and shape, a future prospect, a price, and approval data related to approval and non-approval for use.

11. The method according to claim 9, further comprising the steps of:
surveying on predetermined items based on said updated parts information list; and
creating and then outputting decision information for compatibility prediction based on results from said survey.

12. The method according to claim 9, further comprising the steps of:
storing predetermined information on simulation models, based on technical requirements;
carrying out simulation steps using parameters corresponding to models selected from said simulation models; and
creating prediction information based on simulation results.

13. The method according to claim 9, further comprising the steps of:
estimating packaging densities for an arrangement with all components mounted within a desired layout area based on said updated parts information list in said structured parts list information; and
creating and then outputting decision information for compatibility prediction based on packaging density results.

14. The method according to claim 9, further comprising the steps of:
estimating packaging densities for an arrangement with all components mounted within a desired layout area based on said updated parts information list in said structured parts list information together with predetermined restrictions; and
producing and then outputting decision information for compatibility prediction based on packaging density results.

15. The method according to claim 14,
wherein:
said predetermined restrictions include at least restrictions concerning layout blocked area, part height, connector position, part location, pattern routing, and equal-trace-length requirements.

16. A computer accessible storage medium configured to store structured parts list creating and editing programs for a computer to execute a plurality of processing steps, said processing steps comprising the steps of:
storing structured parts list information on components including a plurality of kinds of parts;
storing parts information on components including a plurality of parts;
retrieving parts information on respective parts, in said structured parts list information;
creating a parts information list of said respective parts; and
creating and editing updated structured parts list information based on said parts information list.

17. The computer accessible storage medium according to claim 16,
wherein:
said parts information on respective parts include information on, at least, an identification, a function, a manufacture, a feature of at least one of size and shape, a future prospect, a price, and approval data related to approval and non-approval for use.

18. The computer accessible storage medium according to claim 16, said processing steps further comprising the steps of:
surveying on predetermined items based on said updated parts information list; and
creating and then outputting decision information for compatibility prediction based on results from said survey.

19. The computer accessible storage medium according to claim 16, said processing steps further comprising the steps of:
storing predetermined information on simulation models, based on technical requirements;
carrying out simulation steps using parameters corresponding to models selected from said simulation models; and
generating prediction information based on simulation results.

20. The computer accessible storage medium according to claim 16, said processing steps further comprising the steps of:
estimating packaging densities for an arrangement with all components mounted within a desired layout area based on said updated parts information list in said structured parts list information; and
producing and then outputting decision information for compatibility prediction based on packaging density results.

21. The computer accessible storage medium according to claim 16, said processing steps further comprising the steps of:
estimating packaging densities for an arrangement with all components mounted within a desired layout area based on said updated parts information list in said structured parts list information together with predetermined restrictions; and
producing and then outputting decision information for compatibility prediction based on packaging density results.

22. The computer accessible storage medium according to claim 21,
wherein:
said predetermined restrictions include at least restrictions concerning layout blocked area, part height, connector position, part location, pattern routing, and equal-trace-length requirements.

23. A system for creating and editing structured parts list information, comprising:
structured parts list information storage means for storing structured parts list information on components including a plurality of kinds of parts;
parts information storage means for storing parts information on components including a plurality of kinds of parts;
parts information list creating and editing means for retrieving parts information on respective parts, stored in said structured parts list information storage means, and for creating a parts information list; and
structured parts information list creating and editing means for creating updated structured parts list information based on said parts information list created by said parts information list creating and editing means.

24. The system according to claim 23, further comprising:
compatibility prediction information output means for surveying on predetermined items based on said parts information list created by said parts information list creating and editing means, and for creating and then outputting decision information for compatibility prediction based on results from said survey.

25. The system according to claim 23, further comprising:
compatibility prediction information output means for storing predetermined information on simulation models, based on technical requirements, for carrying out simulation steps using parameters corresponding to models selected from said simulation models, and for creating prediction information based on simulation results.

26. The system according to claim 23, further comprising:
compatibility prediction information output means for estimating packaging densities for an arrangement with all components mounted within a desired layout area based on said updated parts information list in said structured parts information list, and for creating and then outputting decision information for compatibility prediction based on packaging density results.

27. The system according to claim 23, further comprising:
compatibility prediction information output means for estimating packaging densities for an arrangement with all components mounted within a desired layout area based on said updated parts information list in said structured parts information list together with predetermined restrictions, and for creating and then outputting decision information for compatibility prediction based on packaging density results.

28. A computer accessible storage medium configured to store structured parts list creating and editing programs for a computer to execute a plurality of processing steps, said processing steps comprising the steps of;
storing structured parts list information on components including a plurality of kinds of parts;
retrieving parts information on respective parts, in said structured parts list information;
creating a parts information list of said respective parts; and
creating and editing updated structured parts list information based on said parts information list.

29. The computer accessible storage medium according to claim 28, said processing steps further comprising the steps of:
surveying on predetermined items based on said updated parts information list; and
creating and then outputting decision information for compatibility prediction based on results from said survey.

30. The computer accessible storage medium according to claim 28, said processing steps further comprising the steps of:
storing predetermined information on simulation models, based on technical requirements;
carrying out simulation steps using parameters corresponding to models selected from said simulation models; and
generating prediction information based on simulation results.

31. The computer accessible storage medium according to claim 28, said processing steps further comprising the steps of:
estimating packaging densities for an arrangement with all components mounted within a desired layout area based on said updated parts information list in said structured parts list information; and
producing and then outputting decision information for compatibility prediction based on packaging density results.

32. The computer accessible storage medium according to claim 28, said processing steps further comprising the steps of:
estimating packaging densities for an arrangement with all components mounted within a desired layout area based on said updated parts information list in said structured parts list information together with predetermined restrictions; and
producing and then outputting decision information for compatibility prediction based on packaging density results.
